(19) United States
(12) Patent Application Publication
(10) Pub. No.: US 2018/0225659 A1
(43) Pub. Date: Aug. 9, 2018

(54) INFORMATION PROCESSING DEVICE AND INFORMATION PROCESSING METHOD

(71) Applicant: NOMURA RESEARCH INSTITUTE, LTD., Tokyo (JP)

(72) Inventors: Takao YAMASAKI, Tokyo (JP); Fumio Igarashi, Tokyo (JP); Natsuhiko Sakimura, Tokyo (JP)

(73) Assignee: NOMURA RESEARCH INSTITUTE, LTD., Tokyo (JP)

(21) Appl. No.: 15/943,017

(22) Filed: Apr. 2, 2018

Related U.S. Application Data
(63) Continuation of application No. PCT/JP2016/079231, filed on Oct. 3, 2016.
Application No. PCT/JP2016/079231 is a continuation of application No. PCT/JP2015/078016, filed on Oct. 2, 2015.

(51) Int. Cl. G06Q 20/38; G06Q 20/10; G06Q 20/40

(52) U.S. Cl. CPC G06Q 20/385; G06Q 20/1085; G06Q 2220/00; G06Q 20/3829; G06Q 20/4014

(57) ABSTRACT

In the present invention a fee payment gateway (GW) 12 manages a money pool which collectively holds money to be paid to a plurality of individuals by a fee payment company A, which is a money payment agent. In response to a request from a company terminal 200a, the fee payment GW 12 stores payment information specifying the IDs of individuals, that is, money payment destinations, and payment amounts. When an individual's ID is input from an ATM 20a and a plurality of items of payment information specifying that individual's ID are being stored, the fee payment GW 12 withdraws from the money pool of the fee payment company A the total amount of the payment amounts specified by the plurality of items of payment information, and dispenses that total amount from the ATM 20a.

### BACKGROUND

### Technical Field

The present invention relates to a data processing technique, and particularly relates to an information processing device and an information processing method.

### Related Art

My Number (registered trademark) is going to be individually issued to the citizens from October, 2015. My Number having a 12-digit number is ID not to be changed in a lifetime in principle. From 2016, My Number is going to be required in administrative procedures, such as social insurance, tax, and disaster countermeasures (e.g., refer to JP 2015-79406 A). In accordance with the effect of the My Number system, companies, such as financial institutions, that provide customers with service allowing money reception or money payment to be made, need to acquire the My Number of each customer.

### SUMMARY

Withholding is a system in which, in salary payment or fee payment of companies, income tax is deducted from the payment and then income tax payment is made to administrative agencies, and withholding is intended mainly for payment to individuals. Salary or fee payers need to create withholding certificates, and are required to set the My Number of each individual that receives payment, to a withholding certificate in the future. In accordance with this arrangement, collection or verification of the My Number may cause a significant increase in cost to the companies. The present invention has been made in consideration of the problem, and a main object of the present invention is to assist in achievement of efficient money payment or money reception.

In order to solve the problem, an information processing device according to an aspect of the present invention, includes: a money pool management unit configured to manage a money pool collectively holding money to be paid to a plurality of individuals by a money payment agent; a payment information storage unit configured to store, in response to a request from a device of the money payment agent, payment information specifying identification information regarding an individual being a money payment destination and a payment amount; and a money payment unit configured to withdraw, for input of the identification information regarding the individual from an external terminal operated by the individual, the payment amount specified with the identification information regarding the individual in the payment information storage unit from the money pool, the money payment unit being configured to cause the external terminal to dispense the payment amount. The money payment unit withdraws, when the payment information storage unit stores a plurality of items of the payment information specifying the identification information regarding the individual input from the external terminal, a total amount of the payment amounts specified with the plurality of items of the payment information from the money pool and causes the external terminal to dispense the total amount.

Another aspect of the present invention relates to an information processing device. The information processing device includes: a money pool management unit configured to manage a plurality of money pools corresponding to a plurality of money payment agents, each money pool collectively holding money to be paid to a plurality of individuals by the money payment agent; a payment information storage unit configured to store, in response to a request from a device of each of the plurality of money payment agents, payment information specifying identification information regarding the money payment agent being a request source, identification information regarding an individual being a money payment destination, and a payment amount; and a money payment unit configured to withdraw, for input of the identification information regarding the individual from an external terminal operated by the individual, the payment amount specified with the identification information regarding the individual in the payment information storage unit from the money pool, the money payment unit being configured to cause the external terminal to dispense the payment amount. The money payment unit withdraws, when the payment information storage unit stores a plurality of items of the payment information specifying the identification information regarding the individual input from the external terminal, the plurality of items of the payment information specifying different money payment agents, the payment amount specified with each item of the payment information from the money pool of the money payment agent specified with each item of the payment information, and causes the external terminal to dispense a total amount of the payment amounts specified with the plurality of items of the payment information.

Still another aspect of the present invention relates to an information processing method. The method to be performed by a computer, includes: managing a money pool collectively holding money to be paid to a plurality of individuals by a money payment agent; storing, in response to a request from a device of the money payment agent, payment information specifying identification information regarding an individual being a money payment destination and a payment amount; withdrawing, for input of the identification information regarding the individual from an external terminal operated by the individual, the payment amount specified with the identification information regarding the individual in the payment information previously stored, from the money pool, and causing the external terminal to dispense the payment amount. The withdrawing and causing include: withdrawing, for previously storage of a plurality of items of the payment information specifying the identification information regarding the individual input from the external terminal, a total amount of the payment amounts specified with the plurality of items of the payment information from the money pool; and causing the external terminal to dispense the total amount.

Yet another aspect of the present invention relates to an information processing method. The method to be performed by a computer, includes: managing a plurality of money pools corresponding to a plurality of money payment agents, each money pool collectively holding money to be paid to a plurality of individuals by the money payment agent; storing, in response to a request from a device of each of the plurality of money payment agents, payment information specifying identification information regarding the money payment agent being a request source, identification information regarding an individual being a money payment destination, and a payment amount; and withdrawing, for input of the identification information regarding the individual from an external terminal operated by the individual, the payment amount specified with the identification information regarding the individual in the payment information previously stored, from the money pool, and causing the external terminal to dispense the payment amount. The withdrawing and causing include: withdrawing, for previously storage of a plurality of items of the payment information specifying the identification information regarding the individual input from the external terminal, the plurality of items of the payment information specifying different money payment agents, the payment amount specified with each item of the payment information from the money pool of the money payment agent specified with each item of the payment information; and causing the external terminal to dispense a total amount of the payment amounts specified with the plurality of items of the payment information.

Note that, any combination of the constituent elements or the expression of the present invention transformed between a method, a system, a computer program, and a recording medium storing the computer program, is also effective as an aspect of the present invention.

According to the present invention, the achievement of the efficient money payment or money reception can be assisted.

### BRIEF DESCRIPTION OF DRAWINGS

FIG. 1 is a diagram of the configuration of a fee payment assistance system according to a first embodiment;

FIG. 2 is a block diagram of the functional configuration of an ATM of FIG. 1;

FIG. 3 is a block diagram of the functional configuration of a fee payment GW of FIG. 1;

FIG. 4 is a sequence diagram of the operation of the fee payment assistance system according to the first embodiment;

FIGS. 5A to 5C are diagrams illustrating exemplary screens to be displayed on an LCD of the ATM;

FIG. 6 is a diagram of the configuration of a fee payment assistance system according to a second embodiment;

FIG. 7 is a block diagram of the functional configuration of a fee payment GW of FIG. 6;

FIG. 8 is a sequence diagram of the operation of the fee payment assistance system according to the second embodiment;

FIG. 9 is a sequence diagram of the operation of a fee payment assistance system according to a third embodiment;

FIG. 10 is a diagram of the configuration of a fee payment assistance system according to a fourth embodiment;

FIG. 11 is a block diagram of the functional configuration of a pool account management server of FIG. 10;

FIG. 12 is a block diagram of the configuration of a fee payment GW of FIG. 10;

FIG. 13 is a sequence diagram of the operation of the fee payment assistance system according to the fourth embodiment;

FIG. 14 is a sequence diagram of the operation of the fee payment assistance system according to the fourth embodiment;

FIG. 15 is a diagram of the configuration of a fee payment assistance system according to a fifth embodiment;

FIG. 16 is a block diagram of the functional configuration of a fee payment GW of FIG. 15;

FIG. 17 is a sequence diagram of the operation of the fee payment assistance system according to the fifth embodiment;

FIG. 18 is a sequence diagram of the operation of the fee payment assistance system according to the fifth embodiment;

FIG. 19 is a diagram of the configuration of a fee payment assistance system according to a sixth embodiment;

FIG. 20 is a block diagram of the functional configuration of a fee payment GW of FIG. 19; and

FIG. 21 is a sequence diagram of the operation of the fee payment assistance system according to the sixth embodiment.

### DETAILED DESCRIPTION

An outline will be first described. In the future, companies need to set the My Number (also referred to as the “Individual Number”) of each individual who receives a fee, to a legal record to be created in accordance with fee payment, and thus need identification for the My Number. The identification includes: verification of whether an individual who presents My Number is the identical person; and verification of whether the My Number is identical to My Number of which the identical person has been notified. The first verification is regarded as personal identification or identity verification of the individual who presents the My Number, and the second verification is regarded as authenticity verification or number verification of the My Number. Note that, My Number and Individual Number in the present specification can be replaced with National Identification Number (e.g., Social Security Number or National Insurance Number) in various countries or regions.

Currently, crowdsourcing has been widespread for procuring and aggregating intellectual productivity or content from a large number of people to yield enterprise results. It can be thought that the spread of crowdsourcing allows companies to pay ever-larger numbers of individuals relatively small fees at ever-higher frequency in the near future. The individuals being fee payment destinations may be changed every payment, differently from fixed employees. Therefore, collection or verification of the My Number of a large number of individuals, may cause a significant increase in cost to the companies.

Respective information processing systems according to first to sixth modes to be carried out (hereinafter, for example, referred to as a “first embodiment”) assist affairs relating to money payment from a company to an individual. Specifically, a plurality of partner companies is provided with service assisting collection and verification of the My Number of an individual being a money payment destination, money payment, and creation of a legal record, with an information terminal, such as an automatic teller machine (ATM). The legal record is a document to be submitted to a public institution, the document stating a fact relating to the money payment, including the My Number of the individual being the money payment destination, and hereinafter is referred to as a withholding certificate. Exemplary application of the information processing system according to each embodiment, to fee payment will be described below. However, the information processing system is not limited to the fee payment, and thus can be applied to various types of money payment, such as salary payment, so that a similar effect is acquired.

Respective specific features according to the embodiments are as follows:

First Embodiment: A fee payment destination is an opened account of an individual being a fee payee.

Second Embodiment: The fund of fees is collectively deposited in a pool account opened in a gateway device by a company, and a fee is paid from the pool account to each individual. Money to be paid is real currency.

Third Embodiment: The fund of fees is collectively deposited in a pool account opened in a gateway device by a company, and a fee is paid from the pool account to each individual. Money to be paid is virtual currency, namely, electronic money.

Fourth Embodiment: A company opens a pool account in a specific bank and collectively deposits the fund of fees in the pool account. Then, a fee is paid from the pool account to each individual.

Fifth Embodiment: The fund of fees is collectively deposited in a pool account opened in a gateway device by a company, and a fee is paid from the pool account to each individual. Each individual that receives the fee, can collectively receive money paid a plurality of times from a money payment agent.

Sixth Embodiment: Money payment security is improved with an information terminal possessed by an individual who receives a fee.

In the following descriptions, an individual number card being one of identity documents that an administrative agency issues to an individual, displays the name, address, date of birth, gender, My Number, and photo of a holder on the faces thereof, and is an IC card recording the information in an IC chip. A cash card is also an IC card, and records at least identification information regarding a card issuing institution and identification information for allowing the card issuing institution to identify the card holder (typically, customer). Linking of My Number includes storing, in a company's information system, identification information (e.g., customer's ID issued by the company) regarding a customer (applicant or user for service) in association with the My Number of the customer. The linking also includes storing identification information regarding the service that the customer uses (e.g., account number or contract number) in association with the My Number of the customer.

### First Embodiment

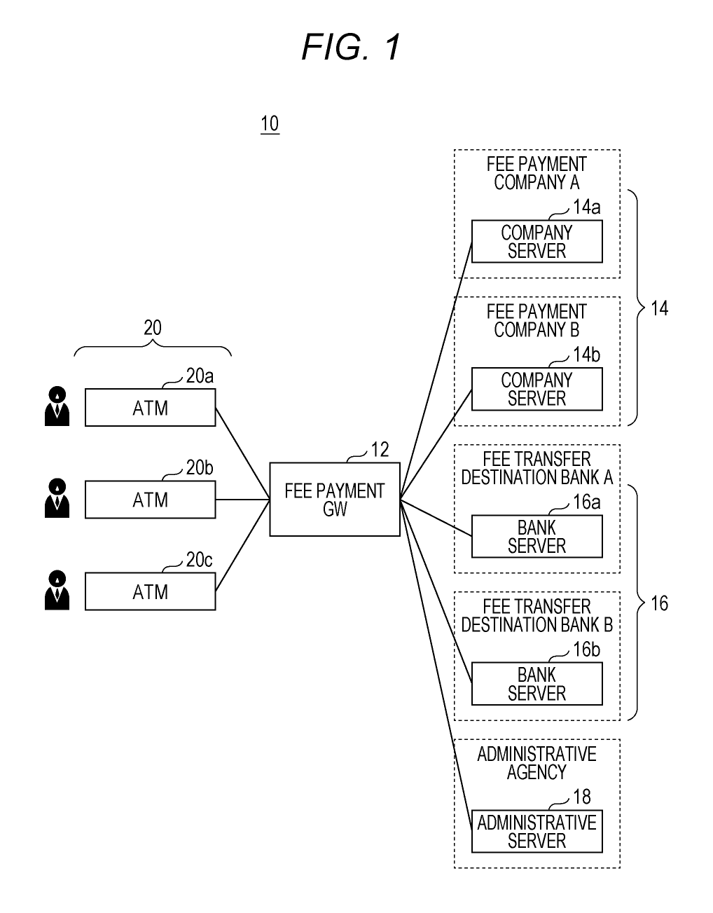

FIG. 1 illustrates the configuration of a fee payment assistance system 10 according to a first embodiment. The fee payment assistance system 10 includes a fee payment gateway (GW) 12, company servers 14a and 14b collectively referred to as a company server 14, bank servers 16a and 16b collectively referred to as a bank server 16, an administrative server 18, ATMs 20a, 20b, and 20c collectively referred to as an ATM 20.

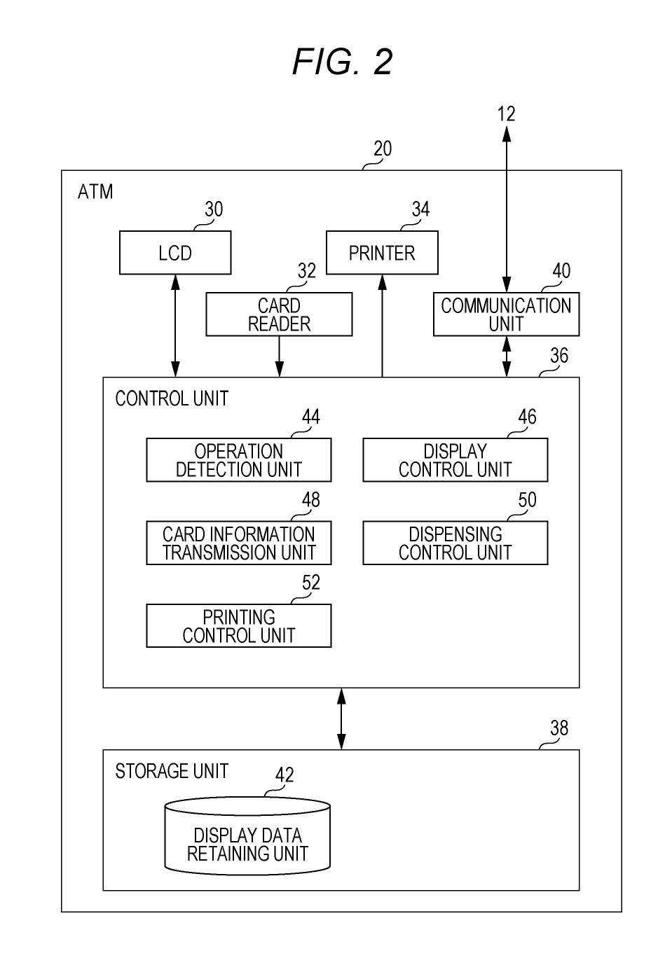

An ATM 20 is an information terminal to be operated by an individual being a fee payment destination (hereinafter, also referred to as a “user”), and provides an interface function with the user, such as display of various messages and read of information input by the user. The ATM 20 is also regarded as a kiosk terminal available for the public, installed in a convenience store, for example. Note that, the information terminal to be used by the user is not necessarily limited to an ATM as long as the information terminal is an apparatus having a function to be described later in relation to FIG. 2.

A company server 14 is an information processing device of a company that provides the fund of a fee to be paid to the individual (hereinafter, also referred to as a “fee payment company”). The fee payment company according to the embodiment, entrusts an actual fee payment procedure to the fee payment GW 12. A bank server 16 is an information processing device of a bank to which the fee to be paid to the individual is transferred (hereinafter, also referred to as a “fee transfer destination bank”). The fee transfer destination bank is a bank in which the individual being the fee payment destination has an account, the bank being allowed to be specified as a fee transfer destination by the individual. Note that, the fee transfer destination is not limited to the bank, and thus may be a different type of financial institution, such as a securities company.

The fee payment GW 12 is an information processing device that undertakes and executes the fee payment procedure to the individual (namely, user of the ATM 20) from the fee payment company. The fee payment GW 12 is regarded as a gateway that collectively undertakes and executes the respective fee payment procedures of a plurality of fee payment companies (fee payment companies A and B) through at least one of a plurality of fee transfer destination banks (fee transfer destination banks A and B). The fee payment GW 12 collects the My Number of the user of the ATM 20, transfers the fee to the user, and creates a withholding certificate, for the fee payment company. The fee payment GW 12 may be a device managed by a provider that provides a fee payment assistance service available for a plurality of companies.

The administrative server 18 is an information processing device retained by an administrative agency, such as the National Tax Administration Agency (revenue office), a local government, or Pension Service. The administrative server 18 functions as a place of submission for a legal record, such as a withholding certificate, and receives data of the legal record online.

The devices of FIG. 1 are connected to each other through a publicly known communication network including the Internet and a dedicated line network. In practice, the fee payment GW 12 may be connected to the ATM 20 through a server, not illustrated, that controls the state and operation of the ATM 20. Needless to say, the fee payment GW 12 may exchange data with the ATM 20 through the server. Needless to say, each device of FIG. 1 may include physically a plurality of devices. For example, the company server 14 is the overall information processing device in the fee payment company, and thus includes a PC that a person in charge in the fee payment company operates, in addition to a narrowly defined server, such as an application server. The bank server 16 and the administrative server 18 are each arranged in a similar manner.

FIG. 2 is a block diagram of the functional configuration of the ATM 20 of FIG. 1. The ATM 20 includes an LCD 30, a card reader 32, a printer 34, a control unit 36, a storage unit 38, and a communication unit 40.

Each block illustrated in the block diagram in the present specification, can be achieved with an element, such as a CPU of a computer, or a mechanical device on a hardware basis, and can be achieved with a computer program on a software basis. Here, the functional blocks to be achieved in cooperation between hardware and software, are illustrated. Therefore, a person skilled in the art should understand that the functional blocks can be variously achieved on the basis of combinations of hardware and software.

For example, a computer program including a module corresponding to each block in the control unit 36, stored in a recording medium, such as a DVD, may be installed into the ATM 20. A processor (e.g., CPU) of the ATM 20 may read the computer program stored in a storage, into a main memory and may execute the computer program to achieve the function of each block. The storage or memory of the ATM 20 storing data may achieve the storage unit 38.

The LCD 30 is a liquid crystal display built in the casing of the ATM 20, and displays various types of electronic content. The LCD 30 has a touch panel function, and functions as information input means. The card reader 32 reads data from an IC card or a magnetic stripe card. The printer 34 prints data to be printed output from the control unit 36, for example, onto rolled paper, to print, for example, a receipt or a withholding certificate.

The control unit 36 performs data processing relating to financial transactions, and additionally performs data processing relating to fee reception, typically, user interface control. The storage unit 38 is a storage area for storing data that the control unit 36 refers to or updates. The communication unit 40 communicates with an external device in accordance with a predetermined communication protocol. For example, the control unit 36 transmits data to or receives data from the fee payment GW 12 through the communication unit 40.

The storage unit 38 includes a display data retaining unit 42. The display data retaining unit 42 retains electronic content to be displayed on the LCD 30, the electronic content being to be presented to the user. Note that, the electronic content to be presented to the user may be retained by the fee payment GW 12, and may be provided from the fee payment GW 12 to the ATM 20 as necessary. Both of the ATM 20 and the fee payment GW 12 may retain a plurality of items of electronic content dispersed.

The control unit 36 includes an operation detection unit 44, a display control unit 46, a card information transmission unit 48, a dispensing control unit 50, and a printing control unit 52.

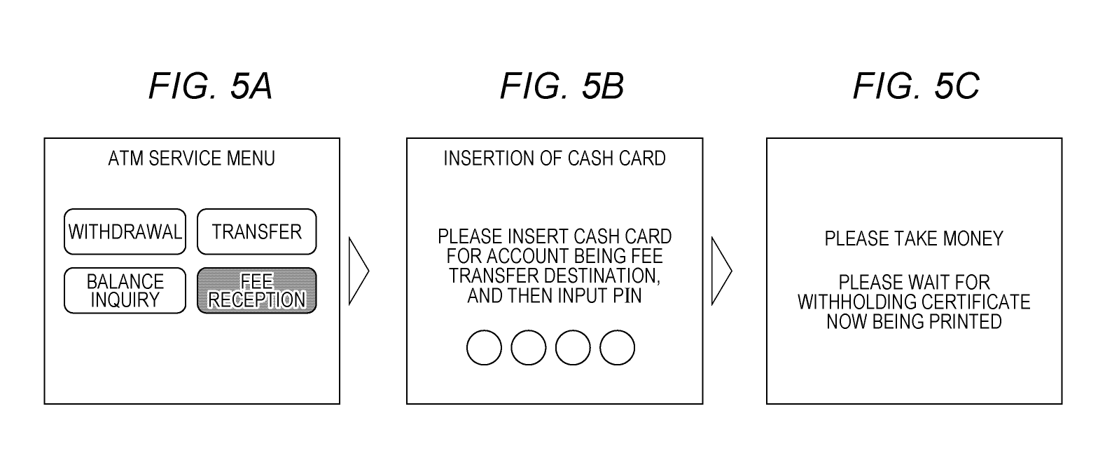

The operation detection unit 44 detects an operation input to the LCD 30 by the user, to notify a different functional block of information indicating the details of the operation. The display control unit 46 controls screen display of the LCD 30. For example, in response to the user operation detected by the operation detection unit 44, the display control unit 46 displays the content retained in the display data retaining unit 42 onto the LCD 30 (e.g., screens exemplified in FIGS. 5A to 5C) or selects the content to be displayed on the LCD 30.

The card information transmission unit 48 transmits information regarding an individual number card or a cash card read by the card reader 32 (hereinafter, also referred to as “card information”) to the fee payment GW 12.

The dispensing control unit 50 controls currency to be dispensed, to provide the currency to the user. The printing control unit 52 that controls printing processing of the printer 34, outputs, for example, the data to be printed to the printer 34 to print the data onto rolled paper.

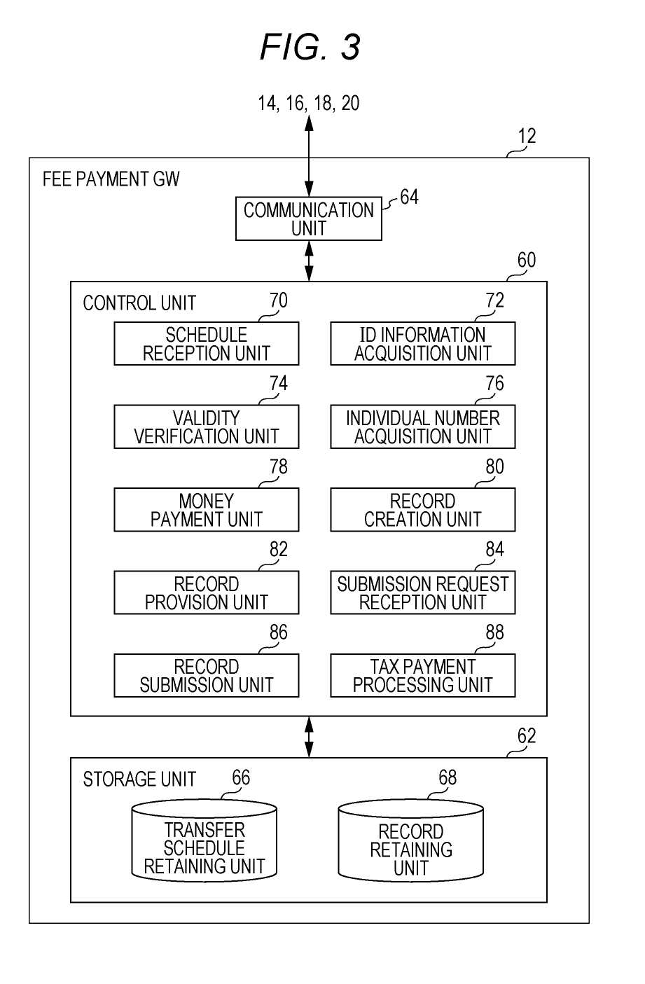

FIG. 3 is a block diagram of the functional configuration of the fee payment GW 12 of FIG. 1. The fee payment GW 12 includes a control unit 60, a storage unit 62, and a communication unit 64. The control unit 60 performs various types of data processing. The storage unit 62 is a storage area for storing data that the control unit 60 refers to or updates. The communication unit 64 communicates with an external device in accordance with the predetermined communication protocol. For example, the control unit 60 transmits data to or receives data from the company server 14, the bank server 16, the administrative server 18, and the ATM 20 through the communication unit 64.

The storage unit 62 includes a transfer schedule retaining unit 66 and a record retaining unit 68. The transfer schedule retaining unit 66 retains transfer schedule data received from the company server 14. The transfer schedule data includes the identifier of the fee payment company, the name of the individual in the fee transfer destination, an account number in the fee transfer destination, and a transfer amount (namely, a fee amount). The record retaining unit 68 retains data of the withholding certificate generated by a record creation unit 80 to be described later.

The control unit 60 includes a schedule reception unit 70, an ID information acquisition unit 72, a validity verification unit 74, an individual number acquisition unit 76, a money payment unit 78, the record creation unit 80, a record provision unit 82, a submission request reception unit 84, a record submission unit 86, and a tax payment processing unit 88.

The schedule reception unit 70 receives data for scheduling the fee (money) payment to the individual, transmitted from the company server 14. According to the first embodiment, the schedule reception unit 70 receives the transfer schedule data for scheduling the fee transfer to the account of the individual. The schedule reception unit 70 stores the transfer schedule data received, into the transfer schedule retaining unit 66.

When the user requests fee reception through the ATM 20, the ID information acquisition unit 72 acquires ID information for identifying the user in the specified fee transfer destination bank, input into the ATM 20. The ID information acquisition unit 72 according to the first embodiment, is also regarded as a card information acquisition unit, and acquires, as the ID information, the card information regarding the cash card transmitted from the ATM 20. The ID information is information stored in the cash card, the information being read from the cash card of the user by the ATM 20. The ID information includes information allocated to the user and information issued to the user by the fee transfer destination bank, and specifically includes the name of the user and the account number. The account number includes a branch code, namely, the identifier of the fee transfer destination bank.

The storage unit 62 of the fee payment GW 12 previously stores the corresponding relationship between the identifiers of the plurality of fee transfer destination banks and the plurality of bank servers 16. The validity verification unit 74 identifies the bank server 16 (e.g., bank server 16a or bank server 16b) associated with the identifier of the fee transfer destination bank included in the ID information, with reference to information indicating the corresponding relationship.

The validity verification unit 74 verifies the validity of the ID information acquired by the ID information acquisition unit 72, in other words, the validity of the card information regarding the cash card, in cooperation with the bank server 16 of the fee transfer destination bank. For example, the validity verification unit 74 verifies whether a simple of each of the name of the user and the account number indicated with the ID information is correct and a combination thereof is correct. The validity verification unit 74 may call a validity-verification web service previously provided in the bank server 16 with the ID information as an argument, to acquire a determined result indicating whether the ID information is valid, from the bank server 16.

The individual number acquisition unit 76 acquires the My Number of the user specified with the ID information regarding the user, in cooperation with the bank server 16 of the fee transfer destination bank. Specifically, when the validity verification unit 74 verifies that the ID information regarding the user is valid, the individual number acquisition unit 76 acquires the My Number of the user previously registered in the fee transfer destination bank, from the bank server 16 of the fee transfer destination bank. The individual number acquisition unit 76 may call an individual-number-acquisition web service previously provided in the bank server 16 with the ID information (e.g., name of the user or account number) as an argument, to acquire the My Number of the user from the bank server 16. The individual number acquisition unit 76 may further acquire different attribute information, for example, so-called basic four-items information including name, gender, date of birth, and address, together with the My Number of the user.

The money payment unit 78 performs money payment processing to the account of the user held in the fee transfer destination bank, the account being specified with the ID information regarding the user. When the validity verification unit 74 verifies that the ID information regarding the user is valid, the money payment unit 78 transfers the transfer amount specified with the transfer schedule data, to the account of the user held in the fee transfer destination bank, the account being indicated with the ID information. The money payment unit 78 may call a transfer web service previously provided in the bank server 16 with the ID information (e.g., account number) and the transfer amount as arguments, to cause the bank server 16 to perform the transfer processing to the account of the user.

The record creation unit 80 creates the withholding certificate when the money payment unit 78 completes the transfer processing to the fee transfer destination bank, properly. Specifically, the record creation unit 80 generates the data of the withholding certificate indicating the completion of the fee payment from the fee payment company to the user, on the basis of the transfer schedule data specifying the My Number of the user in the transfer destination. For example, the data of the withholding certificate includes a transfer date (payment date), the fee amount (payment mount), the name of the user included in the ID information, and the My Number of the user acquired by the individual number acquisition unit 76. The record creation unit 80 stores the data of the withholding certificate generated, into the record retaining unit 68.

The record provision unit 82 provides the withholding certificate created by the record creation unit 80, to at least one of the fee payment company and the user of the ATM 20. The record provision unit 82 according to the first embodiment, transmits the data of the withholding certificate stored in the record retaining unit 68, to the ATM 20, to cause the ATM 20 to print the withholding certificate. In addition, the record provision unit 82 transmits the data of the withholding certificate to the company server 14. For example, the record provision unit 82 may transmit e-mail with the data of the withholding certificate attached, to the company server 14. The company server 14 may be allowed to download the data of the withholding certificate in response to a request from the company server 14, in other words, the data of the withholding certificate may be uploaded to the company server 14 in response to the request from the company server 14.

The submission request reception unit 84 receives data requesting submission of the withholding certificate to the administrative agency (hereinafter, also referred to as a “record submission request”) from the company server 14. The record submission request specifies the identifier of the withholding certificate, for example, an identification number uniquely allocated to each withholding certificate or the name of the user being the payment destination. As to be described later, since payment of income tax is performed together with the submission of the withholding certificate, the record submission request is also regarded as a tax payment request.

When the record submission request is received, the record submission unit 86 transmits the data of the withholding certificate specified with the identifier specified by the record submission request, to the administrative server 18. For example, the record submission unit 86 may call a record-submission web service previously provided in the administrative server 18 with the data of the withholding certificate as an argument, to upload the data of the withholding certificate to the administrative server 18.

When the record submission request is received, the tax payment processing unit 88 performs processing for paying a tax accompanied by the fee payment, for example, the income tax (withholding tax) corresponding to the fee amount, to the administrative agency. The tax payment processing unit 88 according to the first embodiment, performs publicly known electronic tax payment processing, such as direct payment or Internet banking payment, to the administrative server 18 as an opposed device. The tax that the tax payment processing unit 88 pays, should be primarily paid by the fee payment company, and thus the fee payment company pays the tax amount to a company managing the fee payment GW 12, separately.

The operation of the fee payment assistance system 10 having the configuration, will be described.

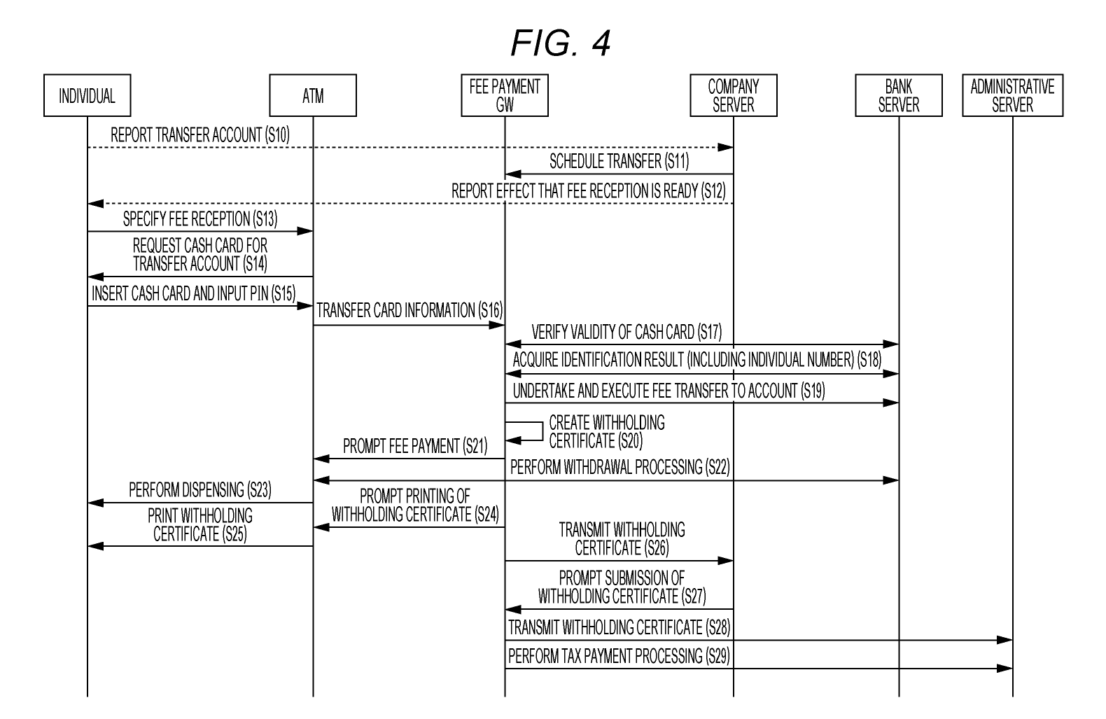

FIG. 4 is a sequence diagram of the operation of the fee payment assistance system 10 according to the first embodiment. FIGS. 5A to 5C illustrate exemplary screens to be displayed on the LCD 30 of the ATM 20. Here, the fee payment company A transfers the fee for a user, to the fee transfer destination bank A, and the user operates the ATM 20a to receive the fee. Therefore, an ATM of FIG. 4 indicates the ATM 20a; a company server of FIG. 4 indicates the company server 14a; and a bank server of FIG. 4 indicates the bank server 16a. When the information terminal that the user operates is the ATMs 20b or 20c, when the fee payment source is the fee payment company B, or when the fee transfer destination is the fee transfer destination bank B, the opposed device of the fee payment GW 12 varies, but the operation of the entire system is arranged in a similar manner.

The user being the fee payee notifies the fee payment company A of the account number (including the identifier of the fee transfer destination bank A) as the fee transfer destination (S10). The notification may be issued from a PC of the user to the company server 14a by e-mail, or the user may contact a person in charge in the fee payment company A by telephone or different offline means. The company server 14a transmits the transfer schedule data specifying the account number specified by the user and the transfer amount, to the fee payment GW 12, to make registration (S11). The fee payment company A notifies the user of the effect that the fee has been transferred, in other words, the effect that the fee is ready to be received (S12). The notification may be issued from the company server 14a to the PC of the user by e-mail, or the person in charge in the fee payment company A may contact the user by telephone or different offline means.

When the user inputs a transaction start operation into the ATM 20a, the display control unit 46 of the ATM 20a displays a menu screen as an initial screen onto the LCD 30 (refer to FIG. 5A). When fee reception is selected on the menu screen (S13), the display control unit 46 of the ATM 20a displays a PIN input screen prompting insertion of a cash card, onto the LCD 30 (refer to FIG. 5B) (S14). The user inserts a cash card for the fee transfer destination bank A, into the ATM 20a and then inputs the PIN code (personal identification number) of the cash card into the ATM 20a. The card information transmission unit 48 of the ATM 20a verifies the correctness of the PIN code with a publicly known method, and transmits, when the PIN code is correct, the card information regarding the cash card read by the card reader 32, to the fee payment GW 12 (S16).

The ID information acquisition unit 72 of the fee payment GW 12 acquires the card information regarding the cash card transmitted from the ATM 20a. The validity verification unit 74 verifies whether the card information (ID information) is valid, on the basis of the ID information regarding the user included in the card information, in cooperation with the bank server 16a (S17). For example, when the name of the user and the account number included in the card information are in agreement with a name and an account number managed in the fee transfer destination bank A, the validity verification unit 74 determines that the card information is valid. When the card information is valid, the individual number acquisition unit 76 acquires the attribute information regarding the user specified with the ID information included in the card information, from the bank server 16a (S18). The attribute information to be acquired is regarded as a result of identification of the user performed by the fee transfer destination bank A in the report of the My Number from the user, and includes at least the My Number of the user.

When it is verified that the ID information regarding the user is valid, the money payment unit 78 of the fee payment GW 12 identifies the transfer schedule data specifying the account number indicated with the ID information, from the transfer schedule data stored in the transfer schedule retaining unit 66. The money payment unit 78 transmits a transfer request specifying the account number indicated with the ID information (or account number specified with the identified transfer schedule data) and the transfer amount specified with the transfer schedule data, to the bank server 16a to transfer the fee to the existing account of the user (S19). The record creation unit 80 creates the withholding certificate indicating the completion of the fee payment from the fee payment company A to the user, and stores the withholding certificate into the record retaining unit 68 (S20).

The money payment unit 78 of the fee payment GW 12 transmits predetermined data prompting the fee payment, the data specifying the transfer amount specified with the transfer schedule data, to the ATM 20a (S21). The dispensing control unit 50 of the ATM 20a performs publicly known deposit withdrawal processing with, as a withdrawal amount, the amount of money specified by the fee payment GW 12 (S22). The dispensing control unit 50 dispenses, in currency, the amount of money withdrawn from the deposit of the user, namely, the fee amount paid from the fee payment company A (refer to FIG. 5C) (S23).

The record provision unit 82 of the fee payment GW 12 acquires the data of the withholding certificate created at S20, from the record retaining unit 68, to transmit the data of the withholding certificate to the ATM 20a (S24). The printing control unit 52 of the ATM 20a causes the printer 34 to print the data of the withholding certificate received from the fee payment GW 12 (S25). Note that, when the ATM 20a has no printer capable of printing the withholding certificate, the record provision unit 82 may transmit the data of the withholding certificate to a predetermined network printer, such as a printer installed in proximity to the ATM 20a or a printer specified by the user, to print the withholding certificate.

The record provision unit 82 of the fee payment GW 12 transmits the data of the withholding certificate created at S20, to the company server 14a (S26). The company server 14a transmits a record submission request including identification information regarding the withholding certificate specified by the person in charge in the fee payment company A, to the fee payment GW 12 (S27). The record submission unit 86 of the fee payment GW 12 transmits the data of the withholding certificate specified by the record submission request, to the administrative server 18 (S28). Simultaneously, the tax payment processing unit 88 of the fee payment GW 12 performs electronic tax payment processing of the withholding tax indicated with the data of the withholding certificate, in cooperation with the administrative server 18 (S29).

In the fee payment assistance system 10 according to the first embodiment, the fee payment GW 12 functions as a platform (gateway) for the fee payment, the creation and submission of the legal record, and the tax payment, and thus the plurality of fee payment companies can render affairs concerning the fee payment, efficient with the fee payment GW 12. The fee payment GW 12 undertakes and executes the collection and verification of the My Number of the individual being the fee payment destination, and thus the fee payment company can easily execute high-frequency fee payment to a large number of individuals. As a result, use of crowdsourcing in the company can be accelerated.

The fee payment GW 12 also undertakes and executes a procedure of submitting the withholding certificate stating the My Number of the individual, to the administrative agency, and thus the fee payment company does not need to know the My Number of the individual being the fee payment destination, namely, does not need strict management of the My Number. Note that, the record provision unit 82 may provide the company server 14 with data excluding the My Number from the original data of the withholding certificate retained in the record retaining unit 68. When image data is provided, the record provision unit 82 may provide the company server 14 with image data of the withholding certificate including a predetermined masking image replacing an image of the My Number.

Modifications will be described below, and the modifications below can be applied to a different embodiment. Not described in the first embodiment, if the My Number of the user of the ATM 20 is unregistered in the fee transfer destination bank, the individual number acquisition unit 76 of the fee payment GW 12 may detect the non-registration and may acquire data of the individual number card input into the ATM 20.

For example, when the individual number acquisition unit 76 requests the bank server 16 of the fee transfer destination bank to provide the My Number of the user and then the bank server 16 returns a response regarding the effect of the non-registration or an error response, the individual number acquisition unit 76 may determine that the My Number of the user is unregistered in the fee transfer destination bank. In this case, the individual number acquisition unit 76 may transmit a message requesting insertion of the individual number card, to the ATM 20 to cause the LCD 30 of the ATM 20 to display the message. The card information transmission unit 48 of the ATM 20 may read an electronic certificate storing the My Number of the user, from the individual number card, to transmit the electronic certificate to the fee payment GW 12.

The individual number acquisition unit 76 of the fee payment GW 12 may unseal the electronic certificate transmitted from the ATM 20, with a publicly known method (e.g., decoding with a public key) to acquire the My Number of the user. In that case, as to be described in a second embodiment, the validity of the electronic certificate may be verified in cooperation with a Japanese Public Key server provided to a predetermined administrative agency. According to the present modification, the processing from S19 of FIG. 4 is performed with the My Number acquired on the basis of the individual number card of the user. This arrangement enables the fee payment GW 12 to perform the fee payment or the legal record creation, even when the My Number of the user is unregistered in the fee transfer destination bank, in other words, even when identification is uncompleted for the My Number of the user in the fee transfer destination bank.

Another modification will be described. According to the first embodiment (S15 to S18 of FIG. 4), the ATM 20 acquires the information regarding the cash card of the user, to transfer the information to the fee payment GW 12 and then the fee payment GW 12 acquires the My Number of the user on the basis of the information regarding the cash card. As the modification, the ATM 20 may acquire the information regarding the individual number card of the user, to transfer the information to the fee payment GW 12 and then the fee payment GW 12 may acquire the My Number of the user on the basis of the information regarding the individual number card. In this case, the ID information acquisition unit 72 of the fee payment GW 12 may acquire the electronic certificate stored in the individual number card as the ID information regarding the user and then may unseal the electronic certificate to acquire the My Number of the user. As described in the previous modification, the validity of the electronic certificate may be further verified. The transfer processing at S19 of FIG. 4 may be performed, on the basis of the account number and the transfer amount indicated with the transfer schedule data, when it is verified that the electronic certificate is valid.

Still another modification will be described. According to the first embodiment, the example in which the fee amount is withdrawn in cash through the ATM 20, has been given, but the processing may be performed only up to the transfer to the account of the user. In this case, the processing from S21 to S23 of FIG. 4 may be skipped. In this case, the information terminal on the user side is required at least to be able to read the cash card and print the withholding certificate, and thus various information terminals are assumed. For example, a multicopy machine or a PC connected to a card reader and a printer, may be provided.

Yet another modification will be described. According to the embodiment, the information terminal that the user being the fee payee uses is the ATM 20, but the user may receive the fee with Internet banking with a PC or a smartphone. In this case, the fee payment GW 12 may provide a Web server function to provide a website having a menu including fee reception. The ID information acquisition unit 72 of the fee payment GW 12 according to the present modification, acquires the ID of the user and the password for logging in to the Internet banking site as the ID information regarding the user.

The validity verification unit 74 of the fee payment GW 12 verifies the validity of the ID and the password transmitted from the information terminal of the user, in cooperation with the bank server 16. The individual number acquisition unit 76 of the fee payment GW 12 acquires the attribute information regarding the user (e.g., My Number) specified with the ID and the password, from the bank server 16. The flow from S19 of FIG. 4 is similar to that according to the first embodiment, but the processing is only up to the transfer to the account of the user. Thus, the processing from S21 to S23 of FIG. 4 is skipped as described in the previous modification.

### Second Embodiment

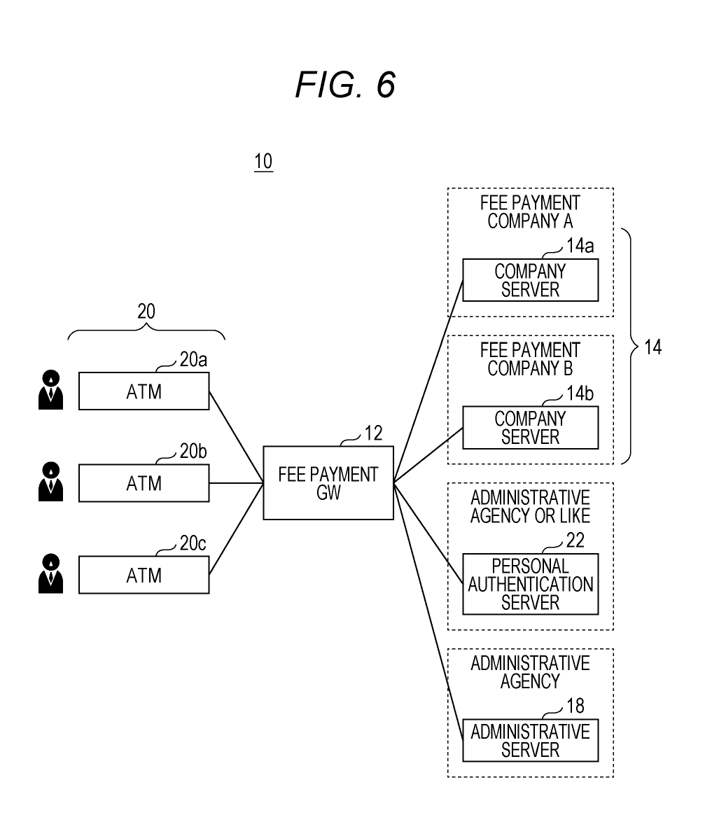

Similarly to the first embodiment, a fee payment assistance system 10 according to a second embodiment is an information processing system relating to money payment from a company to an individual. FIG. 6 illustrates the configuration of the fee payment assistance system 10 according to the second embodiment. According to the second embodiment, instead of a bank server 16, a personal authentication server 22 is connected to a fee payment GW 12.

The personal authentication server 22 is an information processing device managed by an administrative agency or a private company commissioned by the administrative agency, and provides the Japanese Public Key Infrastructure. The personal authentication server 22 retains an invalid list of My Number, and performs processing of verifying the validity of an electronic certificate (My Number) stored in an individual number card, on the basis of a request from the fee payment GW 12.

Descriptions duplicating those according to the first embodiment will be appropriately omitted and differences will be mainly described below.

The functional configuration of an ATM 20 according to the second embodiment, corresponds to the configuration of FIG. 2. A card reader 32 reads an individual number card inserted by a user. A card information transmission unit 48 transmits data of an electronic certificate stored in the individual number card as card information regarding the individual number card, to the fee payment GW 12.

Similarly to the first embodiment, the fee payment GW 12 according to the second embodiment functions as a platform (gateway) assisting fee payment, creation and submission of a legal record, and tax payment. The fee payment GW 12 according to the second embodiment, is different from that according to the first embodiment in that the fee payment GW 12 having a function of managing a money pool collectively holding money to be paid to a plurality of individuals by a company, pays a fee from the money pool to each individual.

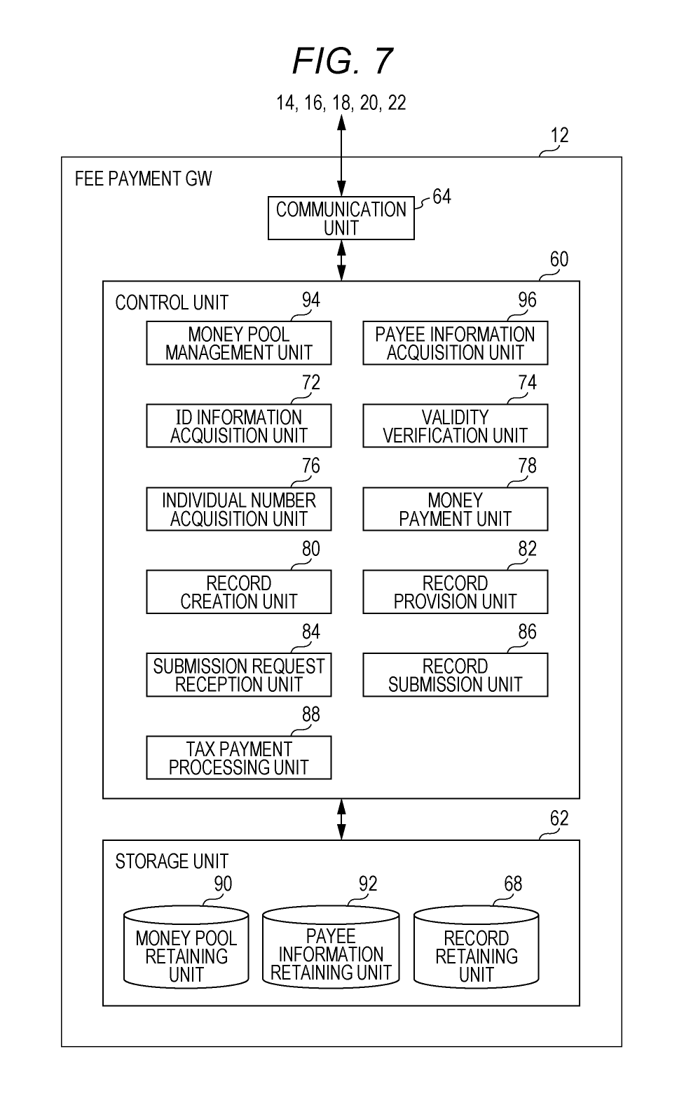

FIG. 7 is a block diagram of the functional configuration of the fee payment GW 12 of FIG. 6. The fee payment GW 12 further includes a money pool retaining unit 90, a payee information retaining unit 92, a money pool management unit 94, and a payee information acquisition unit 96.

The money pool retaining unit 90 stores information regarding a money pool opened by a fee payment company, specifically, information regarding a pool account being an account for fee payment. Specifically, for the pool account opened by a fee payment company A, the money pool retaining unit 90 retains the identifier of the fee payment company A, an account number, and a deposit balance in association with each other. Similarly, for the pool account opened by a fee payment company B, the money pool retaining unit 90 retains the identifier of the fee payment company B, an account number, and a deposit balance in association with each other. The deposit to the pool account is a common fund for fees to be paid to the plurality of individuals by each fee payment company.

The payee information retaining unit 92 stores information regarding an individual being a fee payment destination (hereinafter, referred to as “eligible payee information”). The eligible payee information includes information regarding the identifier of the fee payment company being a fee payment source, the My Number of the individual being the fee payment destination, and the amount of money that the individual is allowed to withdraw from the pool account (hereinafter, referred to as an “allowable withdrawal amount”). The allowable withdrawal amount is also regarded as a fee amount to be paid to the individual.

The money pool management unit 94 performs data processing concerning the management of the pool account. For example, the money pool management unit 94 receives a pool account opening request from a device of the fee payment company (e.g., company server 14a or company server 14b) to record information regarding the pool account into the money pool retaining unit 90. The money pool management unit 94 receives a money deposit request for the opened pool account, from the device of the fee payment company, to increase the pool account balance corresponding to the fee payment company. The money deposit to the pool account may be achieved by a publicly known Internet banking method. For virtually completion of the money deposit, the fee payment company may separately pay actual money to the management company of the fee payment GW 12.

The payee information acquisition unit 96 receives the eligible payee information from the device of the fee payment company A (e.g., company server 14a) or the device of the fee payment company B (e.g., company server 14b), to store the eligible payee information into the payee information retaining unit 92. The money pool management unit 94 may transmit predetermined alert information indicating an insufficient fund, to the fee payment company A (e.g., company server 14a) when the total allowable withdrawal amount indicated with a plurality of items of eligible payee information received from the fee payment company A, exceeds the pool account balance of the fee payment company A. A similar arrangement is made for the pool account of the fee payment company B.

When the user requests fee reception, an ID information acquisition unit 72 acquires ID information regarding the user input into the ATM 20. The ID information acquisition unit 72 according to the second embodiment, is also regarded as a card information acquisition unit, and acquires, as the ID information, card information regarding the individual number card of the user transmitted from the ATM 20. Specifically, the ID information includes an electronic certificate and the public key of the user stored in the individual number card, and the PIN code input into the ATM 20 by the user. Note that, even when a different user selects a fee reception menu on the same ATM 20 or a different ATM 20, the ID information acquisition unit 72 also acquires the ID information regarding the different user.

An individual number acquisition unit 76 unseals the electronic certificate acquired by the ID information acquisition unit 72, to acquire the My Number of the user stored in the electronic certificate. The individual number acquisition unit 76 unseals the respective electronic certificates for a plurality of users who uses the ATM 20, to acquire the My Number of each user. The individual number acquisition unit 76 may decode data of the electronic certificate encrypted with the secret key of the user, with the public key of the user acquired together with the electronic certificate and the PIN code, to acquire the My Number of the user. Note that, the individual number acquisition unit 76 further acquires different attribute information stored in the electronic certificate, such as a photo of the user, a face number, and basic four-items information.

A validity verification unit 74 verifies the validity of the electronic certificate acquired by the ID information acquisition unit 72, in other words, whether the My Number stored in the electronic certificate is valid, in cooperation with the personal authentication server 22. The validity verification unit 74 verifies the validity of the My Number of each of the plurality of users who uses the ATM 20. For example, the validity verification unit 74 may transmit information regarding the electronic certificate acquired by the ID information acquisition unit 72, to the personal authentication server 22, to receive information indicating whether the electronic certificate is valid, from the personal authentication server 22. When the validity verification unit 74 transmits the My Number acquired by the individual number acquisition unit 76, to the personal authentication server 22 and then receives a response regarding the effect that the My Number is not on the invalid list retained in the personal authentication server 22, the validity verification unit 74 may determine that the electronic certificate is valid.

A money payment unit 78 performs processing of paying the fee amount previously specified by the fee payment company, the fee amount being part of money deposited in the pool account of the fee payment company, to each user of the ATM 20. Specifically, when it is verified that the My Number of the user acquired by the individual number acquisition unit 76 is valid and when the My Number has been specified with the eligible payee information stored in the payee information retaining unit 92, the money payment unit 78 performs processing of paying the allowable withdrawal amount specified with the eligible payee information, to the user. For example, the money payment unit 78 may transmit dispensing prompt data specifying the allowable withdrawal amount, to the ATM 20, to cause the ATM 20 to dispense the allowable withdrawal amount in currency.

A record creation unit 80 creates a legal record relating to the fee payment when it is verified that the electronic certificate received from the ATM 20 is valid, in other words, when it is verified that the My Number presented by the user is valid. Specifically, the record creation unit 80 identifies the eligible payee information specifying the My Number of the user, from the eligible payee information stored in the payee information retaining unit 92. Then, the record creation unit 80 generates data of a withholding certificate including the identifier of the fee payment company, the allowable withdrawal amount, the name and My Number of the user, and the payment date indicated with the eligible payee information. The record creation unit 80 stores the data of the withholding certificate generated, into a record retaining unit 68.

The operation of the fee payment assistance system 10 having the configuration, will be described.

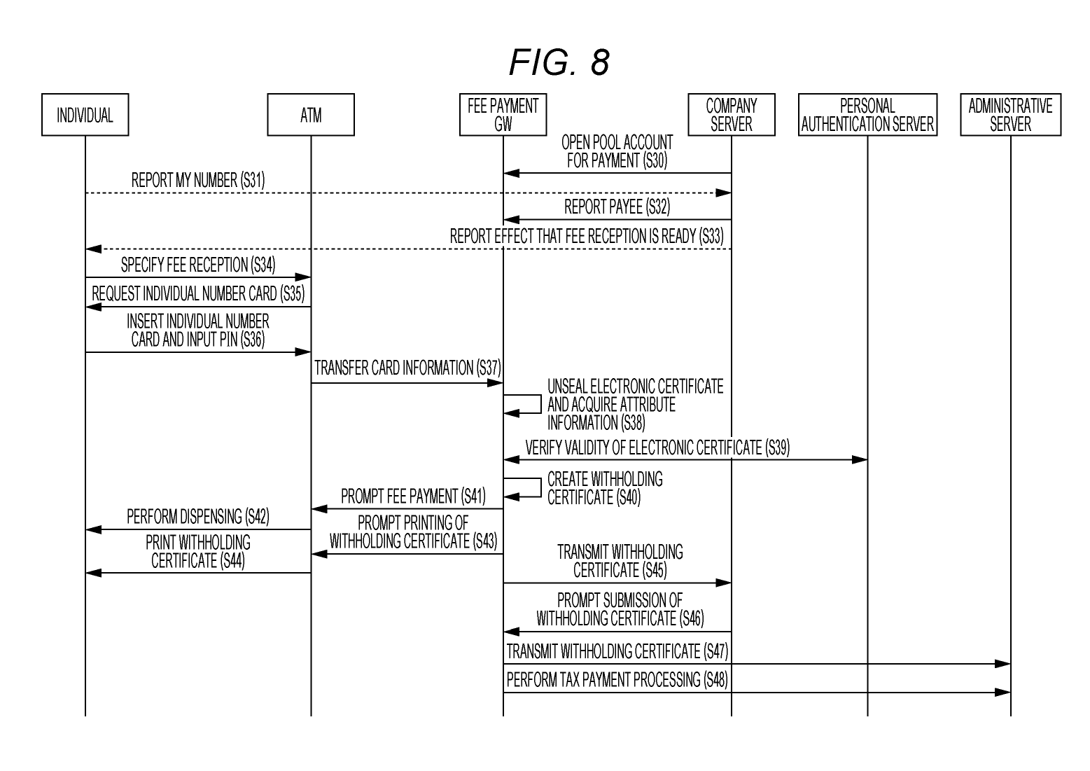

FIG. 8 is a sequence diagram of the operation of the fee payment assistance system 10 according to the second embodiment. Here, the fee payment company A pays the fee to a user, and the user operates an ATM 20a to receive the fee. Therefore, an ATM of FIG. 8 indicates the ATM 20a, and a company server of FIG. 8 indicates the company server 14a. When the information terminal that the user (or a different user) operates is an ATM 20b or 20c or when the fee payment source is the fee payment company B, the opposed device of the fee payment GW 12 varies, but the operation of the entire system is arranged in a similar manner.

The fee payment company A opens the pool account for payment, in the fee payment GW 12 (S30). For example, the company server 14a may transmit the pool account opening request to the fee payment GW 12 online. The money pool management unit 94 of the fee payment GW 12 may perform processing of opening the pool account in response to the request, and may store information regarding the new pool account, into the money pool retaining unit 90. A person in charge in the fee payment company A may contact an administrator of the fee payment GW 12 by telephone or e-mail, to request the opening of the pool account, and then the administrator of the fee payment GW 12 may perform work of opening the pool account.

The user notifies the fee payment company A of the user's My Number by means, such as telephone or e-mail (S31). Every time individual fee payment is required, the company server 14a transmits the eligible payee information specifying the My Number of the individual being the fee payment destination and the allowable withdrawal amount of the individual, to the fee payment GW 12 (S32). The fee payment company A notifies each individual specified with the individual eligible payee information, of the effect that fee reception is ready (S33). For example, the company server 14a may contact a PC of the user by e-mail or the person in charge in the fee payment company A may contact the user by telephone or different offline means.

When the user selects fee reception on a menu screen of the ATM 20a (refer to FIG. 5A) (S34), a display control unit 46 of the ATM 20a displays a screen prompting insertion of the individual number card and input of the PIN code, onto an LCD 30 (S35). The user inserts the individual number card into the ATM 20a and inputs the PIN code of the individual number card into the ATM 20a (S36). The card information transmission unit 48 of the ATM 20a transmits the electronic certificate of the individual number card read by the card reader 32 and the PIN code input by the user, to the fee payment GW 12 (S37).

The ID information acquisition unit 72 of the fee payment GW 12 acquires the electronic certificate of the individual number card and the PIN code transmitted from the ATM 20a. The individual number acquisition unit 76 unseals the electronic certificate with the public key attached to the electronic certificate and the PIN code, to acquire the My Number of the user stored in the data of the electronic certificate (S38). The validity verification unit 74 verifies whether the electronic certificate is valid, in other words, whether the My Number is invalid, in cooperation with the personal authentication server 22 (S39). When it is verified that the electronic certificate is valid, in other words, it is verified that the My Number is valid, the record creation unit 80 creates the withholding certificate indicating completion of the fee payment from the fee payment company A to the user, and then stores the withholding certificate into the record retaining unit 68 (S40).

The money payment unit 78 of the fee payment GW 12 prompts the ATM 20a to dispense the allowable withdrawal amount indicated with the eligible payee information specifying the My Number of the user (S41). A dispensing control unit 50 of the ATM 20a performs processing of dispensing the allowable withdrawal amount, in accordance with the prompt received from the fee payment GW 12 (S42). The subsequent processing from S43 to S48 is arranged similarly to that from S24 to S29 according to the first embodiment. Even when the fee payment company A pays the fee to a different individual and the different individual receives the fee, a similar operation is made. That is, the fee payment GW 12 collects the My Number of the different individual, verifies the validity thereof, and assists the fee payment to the different individual, creation and submission of a legal record, and tax payment.

Similarly to the first embodiment, the fee payment GW 12 functions as a platform (gateway) for the fee payment, the creation and submission of a legal record, and the tax payment, in the fee payment assistance system 10 according to the second embodiment. Use of the fee payment GW 12 enables the plurality of fee payment companies to render affairs concerning the fee payment, efficient. Each fee payment company can easily perform high-frequency fee payment to a large number of individuals.

Modifications will be described below, and the modifications below can be applied to a different embodiment. According to the second embodiment, the ATM 20 reads the individual number card of the user. However, as a modification, for the user's My Number linked with a user's opened bank account (registered), the ATM 20 may read information regarding a cash card of the bank account. A method of acquiring the My Number of the user according to the present modification, is similar to that according to the first embodiment. That is, in cooperation with a device of a bank holding the account of the user, the individual number acquisition unit 76 of the fee payment GW 12 may acquire the My Number of the user registered in the bank.

As described in the modification according to the first embodiment, for the user's My Number linked with the user's opened bank account, the ID and password of the user for logging in to an Internet banking site may be input into the ATM 20. In cooperation with the device of the bank, the individual number acquisition unit 76 of the fee payment GW 12 may acquire the My Number of the user specified with the ID and password for the Internet banking site input into the ATM 20.

Another modification will be described. According to the second embodiment, the ATM 20 dispenses cash, but the allowable withdrawal amount may be transferred to an account specified by the user of the ATM 20 or an account specified by the fee payment company on the basis of specification of the user (e.g., account specified with the payee information). In this case, the money payment unit 78 of the fee payment GW 12 may transmit a transfer request specifying the account number specified by the user or the fee payment company and the allowable withdrawal amount, to the device of the bank, to transfer the fee from the pool account of the fee payment company to the bank account of the user. In this case, the information terminal on the user side is required at least to be able to read the individual number card and print the withholding certificate, and thus various information terminals are assumed. For example, a multicopy machine or a PC having a card reader and a printer, may be provided.

Yet another modification will be described. According to the second embodiment, with the My Number identified on the basis of the individual number card of the user as a key, the eligible payee information for the user is identified. As the modification, with attribute information regarding the user, excluding the My Number, as the key, the eligible payee information for the user may be identified. For example, information excluding the My Number, stored in the electronic certificate of the individual number card, may be used as the key. Specifically, a simple of each of the name, date of birth, and face number of the user or a combination thereof may be used as the key. An e-mail address retained by the user may be used as the key. In this case, the user further inputs the e-mail address at S36 of FIG. 8, and then the ATM 20 notifies the fee payment GW 12 of the e-mail address.

### Third Embodiment

Similarly to the second embodiment, a fee payment assistance system 10 according to a third embodiment is an information processing system relating to money payment from a company to an individual. Similarly to the second embodiment, a fee payment GW 12 according to the third embodiment functions as a platform (gateway) assisting fee payment, creation and submission of a legal record, and tax payment. Note that, the third embodiment is different from the second embodiment in that electronic money being virtual currency is paid as a fee to a user. Descriptions duplicating those according to the first and second embodiments will be appropriately omitted and differences will be mainly described below.

The configuration of the fee payment assistance system 10 according to the third embodiment, corresponds to the configuration of FIG. 6, but various information terminals are assumed as an information terminal that the user uses. For example, an ATM 20 or a multicopy machine installed in a convenience store may be provided or a PC installed in the house of the user may be provided. For the ATM 20, a configuration similar to that of the ATM 20 according to the second embodiment, may be provided.

According to the third embodiment, the information terminal that the user uses is a general PC having a Web browser installed. For My Number verification of the fee payment GW 12, the PC of the user transmits an captured image of a face of an individual number card possessed by the user (hereinafter, referred to as an “individual number card image”) as ID information, to the fee payment GW 12.

The functional configuration of the fee payment GW 12 according to the third embodiment, corresponds to the configuration of FIG. 7. According to the third embodiment, an electronic money pool for payment is opened as a money pool of a fee payment company. The fee payment GW 12 has a function as a Web server, and opens a Web site for fee reception procedure on the Internet. The fee payment GW 12 may further include a Web page provision unit that provides a Web page of the Web site for fee reception procedure, to the PC of the user.

An individual number acquisition unit 76 of the fee payment GW 12 acquires the individual number card image transmitted from the PC of the user as the ID information and performs optical character recognition (OCR) processing to the image, to read various types of attribute information, such as the My Number of the user and basic four-items information, as electronic data.

With reference to eligible payee information specifying the My Number identified by the individual number acquisition unit 76, a money payment unit 78 issues the electronic money for an allowable withdrawal amount specified with the eligible payee information, to the user. The electronic money may be issued by a publicly known method. For example, the money payment unit 78 may transmit data indicating the effect of the issue of the electronic money for the allowable withdrawal amount, to the PC of the user. When a server on a communication network manages the electronic money retained by the user, the money payment unit 78 may transmit data indicating the effect of the issue of the electronic money for the allowable withdrawal amount to the user, to the server.

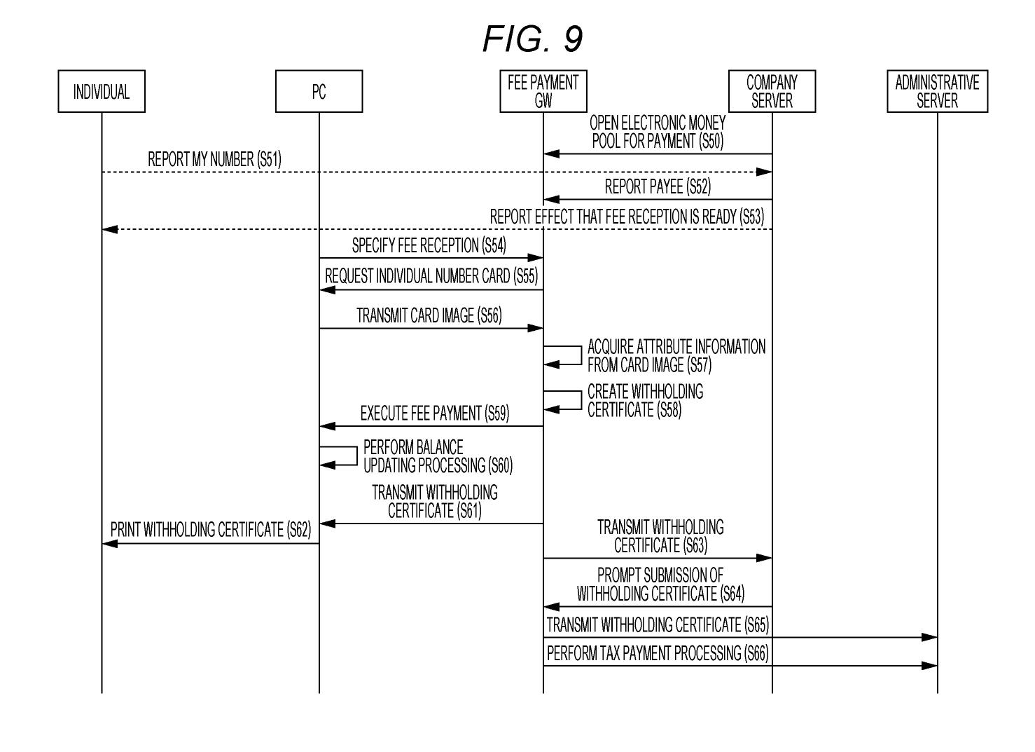

FIG. 9 is a sequence diagram of the operation of the fee payment assistance system 10 according to the third embodiment. The operation from S50 to S53 of FIG. 9 is similar to the operation from S30 to S33 according to the second embodiment illustrated in FIG. 8. Similarly to the second embodiment, a fee payment source is a fee payment company A, but the money pool that the fee payment company A opens is intended for electronic money.

The user operates the PC to access the Web site for fee reception procedure, provided by the fee payment GW 12 (S54). The fee payment GW 12 provides the PC of the user with a Web page prompting uploading of the individual number card image, to cause the PC of the user to display the Web page (S55). The user operates the PC to upload the individual number card image previously created, to the fee payment GW 12 (S56). An ID information acquisition unit 72 of the fee payment GW 12 acquires the individual number card image, and the individual number acquisition unit 76 identifies the attribute information including the My Number of the user, on the basis of the image (S57).

A record creation unit 80 of the fee payment GW 12 generates data of a withholding certificate indicating completion of the fee payment from the fee payment company A to the user, and stores the withholding certificate into a record retaining unit 68 (S58). The money payment unit 78 of the fee payment GW 12 transmits the data indicating the effect of the issue of the electronic money for the allowable withdrawal amount indicated with the eligible payee information specifying the My Number of the user, to the PC of the user (S59). The PC of the user performs publicly known processing of increasing the electronic money balance (S60). For example, an IC card for electronic money management may record the electronic money issued from the fee payment GW 12, through a card writer connected to the PC.

A record provision unit 82 of the fee payment GW 12 transmits the data of the withholding certificate created at S58, to the PC of the user (S61), and the PC of the user causes a printer to print the withholding certificate (S62). The subsequent processing from S63 to S66 is similar to that from S26 to S29 according to the first embodiment. For the fee payment source being a fee payment company B (company server 14b), for use of his/her own PC by a different user, or for use of the ATM 20 or the multicopy machine, a similar operation is made.

Similarly to the first and second embodiments, the fee payment GW 12 functions as the platform (gateway) assisting the fee payment, the creation and submission of a legal record, and the tax payment, in the fee payment assistance system 10 according to the third embodiment. Use of the fee payment GW 12 enables the plurality of fee payment companies to render affairs concerning the electronic money payment for fees, efficient. Each fee payment company can easily perform high-frequency fee payment to a large number of individuals.

According to the third embodiment, the electronic money is paid as the fee to the user, instead of real currency. Thus, as simple number verification, the individual number card image is uploaded and then the My Number is read from the image. Verification of the validity of the My Number (S39 of FIG. 8) is skipped. As a modification, with the ATM 20, the multicopy machine, or the PC equipped with a card reader as the information terminal on the user side, number verification may be performed with an electronic certificate stored in the individual number card, similarly to the second embodiment. Similarly to the second embodiment, processing of verifying the validity of the electronic certificate (My Number) may be performed in cooperation with a personal authentication server 22.

### Fourth Embodiment

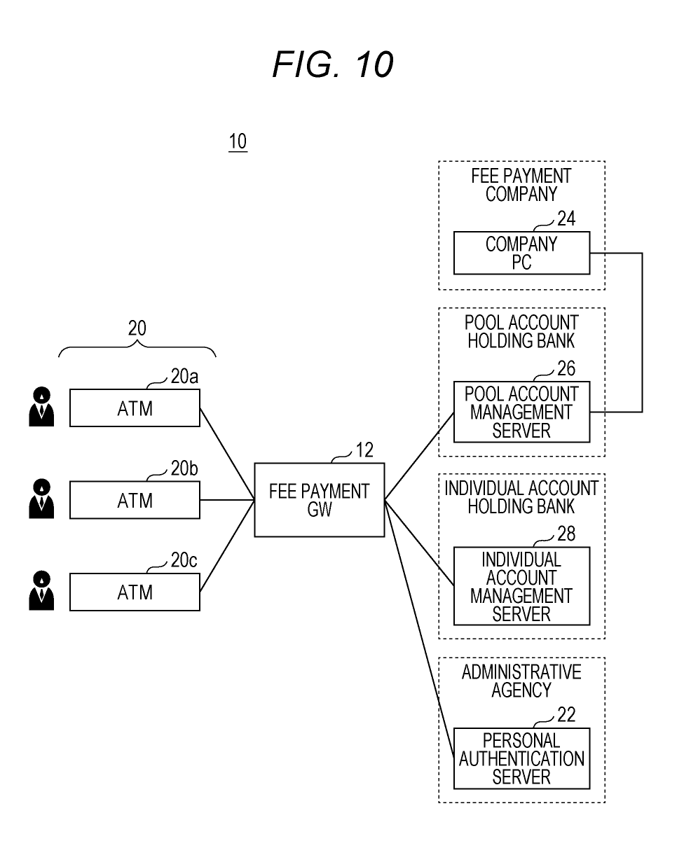

Similarly to the first to third embodiments, a fee payment assistance system 10 according to a fourth embodiment is an information processing system relating to money payment from a company to an individual. FIG. 10 illustrates the configuration of the fee payment assistance system 10 according to the fourth embodiment. From the constituent elements illustrated in FIGS. 10 to 12, constituent elements the same as or corresponding to those already described in the first to third embodiments, are denoted with the same reference signs. Descriptions duplicating those according to the first to third embodiments will be appropriately omitted and differences will be mainly described below.

A company PC 24 is an information processing device (here, PC) that a person in charge in a fee payment company operates. The company PC 24 may be, for example, a smartphone or a tablet terminal. A pool account management server 26 is an information processing device retained by a bank at which a fee payment company has a pool account being an account for fee payment (hereinafter, referred to as a “pool account holding bank”). An individual account management server 28 is an information processing device retained by a bank at which an individual being a fee payment destination (namely, user of an ATM 20) has a savings account (hereinafter, referred to as an “individual account holding bank”). The pool account management server 26 and the individual account management server 28 each correspond to the bank server 16 according to the first embodiment.

FIG. 10 illustrates one fee payment company, one pool account holding bank, and one individual account holding bank, for simplification of descriptions. Needless to say, a plurality of agents may be provided for each of the items. That is, the fee payment assistance system 10 may include: a plurality of company PCs 24 corresponding to a plurality of fee payment companies; a plurality of pool account management servers 26 corresponding to a plurality of pool account holding banks; and a plurality of individual account management servers 28 corresponding to a plurality of individual account holding banks.

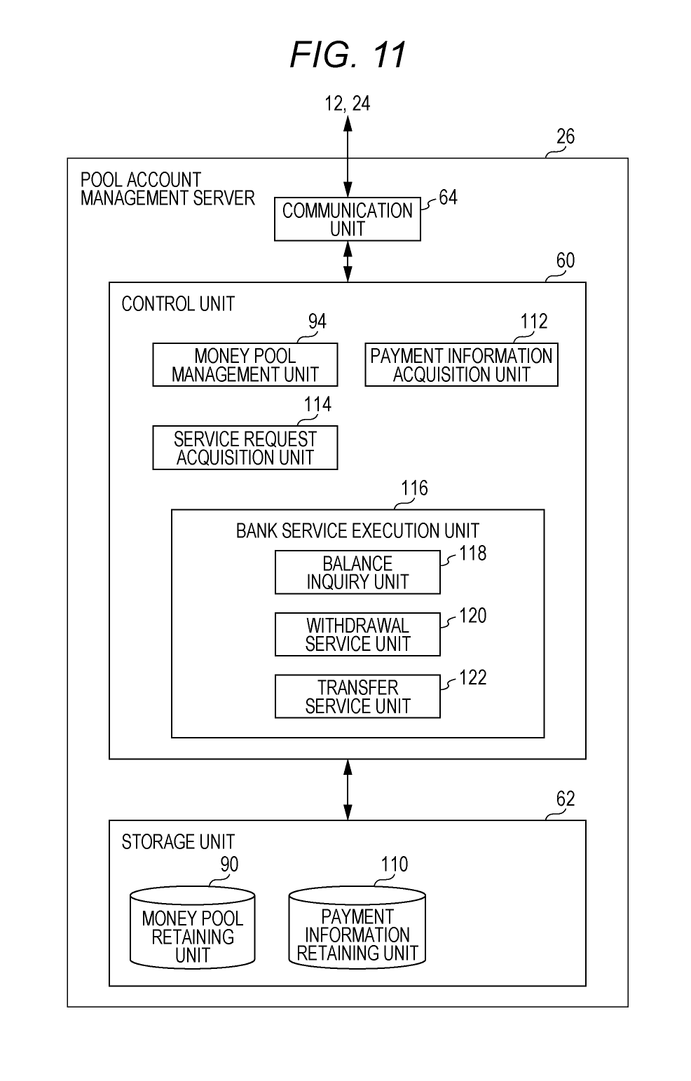

FIG. 11 is a block diagram of the functional configuration of the pool account management server 26 of FIG. 10. A storage unit 62 of the pool account management server 26 includes a money pool retaining unit 90 and a payment information retaining unit 110.

The money pool retaining unit 90 stores information regarding the pool account opened by the fee payment company. Specifically, for the pool account opened by the fee payment company, the money pool retaining unit 90 retains the identifier of the fee payment company, an account number, and a deposit balance in association with each other. The payment information retaining unit 110 retains payment information including specific ID, a payment amount (in other words, a fee amount to the user), and the account number of the pool account in association with each other.

The specific ID is an identifier previously determined between the fee payment company and the user, and is ID for uniquely identifying fee payment at a timing from a specific fee payment company to a specific user. When the user being a fee payment destination varies or when the user remains unchanged but the timing of the fee payment varies, a different specific ID is set. The specific ID may be a virtual account number linked with the pool account. The specific ID may be data in a format settable to a publicly known online service relating to financial transactions, or may be any character string settable to, for example, a space for notes in CAFIS (trademark or registered trademark).

A control unit 60 of the pool account management server 26 includes a money pool management unit 94, a payment information acquisition unit 112, a service request acquisition unit 114, and a bank service execution unit 116.

The money pool management unit 94 performs data processing concerning management of the pool account, such as opening processing or balance updating processing of the pool account. Specifically, the money pool management unit 94 may receive a pool account opening request from the company PC 24 and record information regarding the pool account into the money pool retaining unit 90, to open the pool account of the fee payment company. The money pool management unit 94 may receive a money deposit request for the opened pool account from the company PC 24, to increase the pool account balance.

The payment information acquisition unit 112 receives the payment information transmitted from the company PC 24, and stores the payment information into the payment information retaining unit 110. The service request acquisition unit 114 receives a service request transmitted from the fee payment GW 12. The service request includes the specific ID input into the ATM 20 by the user.

When the service request is received, the bank service execution unit 116 identifies the pool account and the payment amount associated with the specific ID included in the service request. Then, the bank service execution unit 116 performs bank service data processing in accordance with the payment amount, to provide a processing result thereof to the ATM 20. The bank service execution unit 116 includes a balance inquiry unit 118, a withdrawal service unit 120, and a transfer service unit 122.

The balance inquiry unit 118 performs balance inquiry processing of presenting the payment amount to the user, namely, the fee amount that the user can withdraw. The withdrawal service unit 120 performs withdrawal processing of allowing the ATM 20 to dispense the payment amount to the user. The transfer service unit 122 performs transfer processing of transferring the payment amount to the user to an account specified by the user. The bank service execution unit 116 may further include a functional block for providing a different type of bank service.

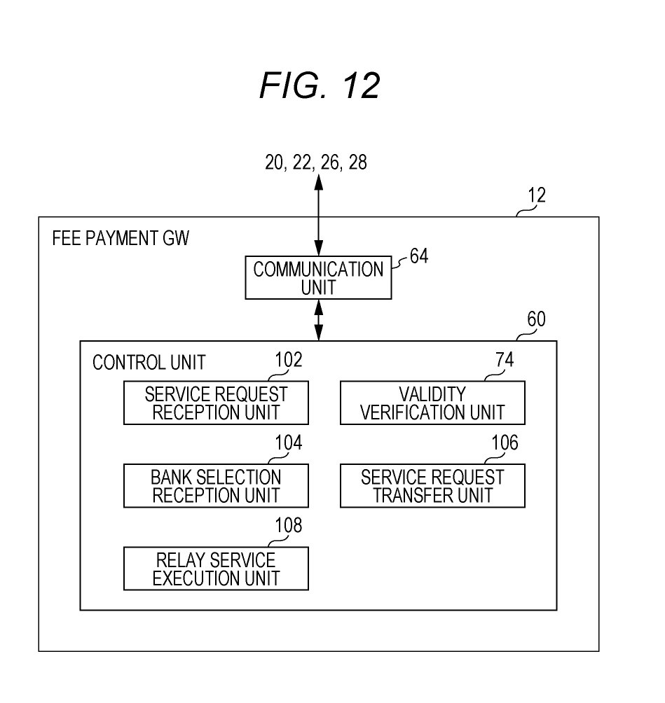

FIG. 12 is a block diagram of the configuration of the fee payment GW 12 of FIG. 10. The fee payment GW 12 includes a service request reception unit 102, a validity verification unit 74, a bank selection reception unit 104, a service request transfer unit 106, and a relay service execution unit 108.

The service request reception unit 102 receives the service request transmitted from the ATM 20. The service request includes information indicating a service desired by the user (hereinafter, referred to as “specified service information”), an electronic certificate read from an individual number card, the PIN code of the individual number card input by the user, and the specific ID.

The validity verification unit 74 verifies the validity of the electronic certificate included in the service request. For example, when the validity verification unit 74 acquires the My Number stored in the electronic certificate with the PIN code and then verifies the validity of the My Number in cooperation with a personal authentication server 22, the validity verification unit 74 may determine that the electronic certificate is valid. The validity verification unit 74 verifies the validity of cash card information included in the service request. For example, the validity verification unit 74 may transmit the cash card information and the PIN code to the individual account management server 28, to receive information indicating whether the cash card information is valid, from the individual account management server 28.

The bank selection reception unit 104 receives bank selection information transmitted from the ATM 20. The bank selection information includes information regarding a bank holding the fee to be paid to the user, the bank being the pool account holding bank in the fourth embodiment. The service request transfer unit 106 transfers the service request transmitted from the ATM 20, to the pool account management server 26. The service request includes the specified service information and the specific ID.

The relay service execution unit 108 provides the ATM 20 with an information relay service as a gateway. For example, when the specified service information specifies balance inquiry, the relay service execution unit 108 transfers fee balance information transmitted from the pool account management server 26, to the ATM 20. When the specified service information specifies withdrawal, the relay service execution unit 108 transmits prompt data for dispensing the fee amount, to the ATM 20. When the specified service information specifies transfer, the relay service execution unit 108 transfers information regarding a transfer result transmitted from the pool account management server 26, to the ATM 20.

The operation of the fee payment assistance system 10 having the configuration, will be described.

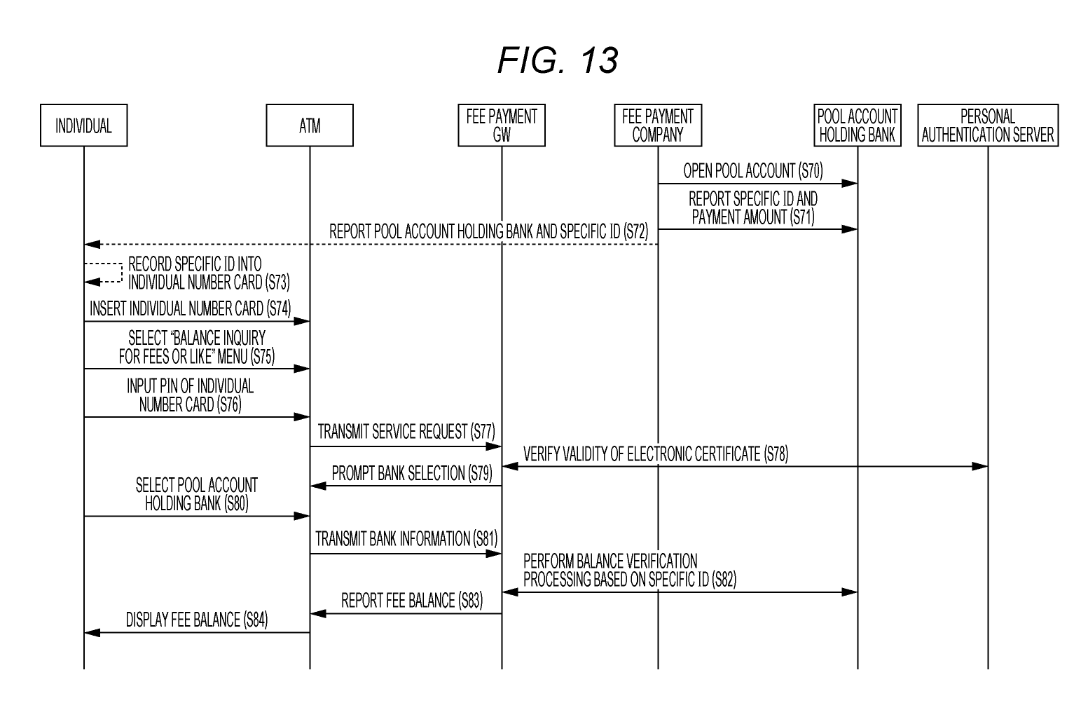

FIG. 13 is a sequence diagram of the operation of the fee payment assistance system 10 according to the fourth embodiment. FIG. 13 illustrates the operation when the user selects balance inquiry as a bank service, with the individual number card. FIG. 13 illustrates a method in which the fee payment company determines the specific ID and notifies the user of the specific ID, as a method of sharing the specific ID between the fee payment company and the user.

The company PC 24 of the fee payment company transmits the pool account opening request to the pool account management server 26, and the money pool management unit 94 of the pool account management server 26 opens the pool account of the fee payment company (S70). At fee payment timing to the user, the person in charge in the fee payment company causes the company PC 24 to transmit the payment information including the specific ID allocated to the fee payment this time, the payment amount, and the account number of the pool account, to the pool account management server 26 (S71). The payment information acquisition unit 112 of the pool account management server 26 acquires the payment information transmitted from the fee payment company, to store the payment information into the payment information retaining unit 110.

The person in charge in the fee payment company notifies the user of the name of the pool account holding bank and the specific ID (S72). The notification may be issued, for example, by telephone or mail, or may be issued, for example, by e-mail from the company PC 24 to an information terminal of the user. The user records the specific ID into the user's individual number card with a card writer (S73).

The user inserts the individual number card into the ATM 20 (S74) and then selects “balance inquiry for fees or the like” on a menu screen of the ATM 20 (S75). The ATM 20 displays a PIN input screen, and the user inputs the PIN code of the individual number card onto the PIN input screen (S76). The ATM 20 transmits the service request including: the specified service information indicating “balance inquiry for fees or the like”; the electronic certificate and the specific ID read from the individual number card; and the PIN code input by the user, to the fee payment GW 12 (S77).

The validity verification unit 74 of the fee payment GW 12 verifies the validity of the electronic certificate included in the service request, in cooperation with the personal authentication server 22 (S78). When it is determined that the electronic certificate is valid, the bank selection reception unit 104 of the fee payment GW 12 prompts the ATM 20 to display a bank selection screen (S79). The ATM 20 displays the bank selection screen, and the user selects the pool account holding bank reported at S72 (S80). The ATM 20 transmits bank information including identification information regarding the pool account holding bank selected on the bank selection screen, to the fee payment GW 12 (S81).

The fee payment GW 12 performs the balance inquiry processing based on the specific ID, in cooperation with the pool account management server 26 (S82). Specifically, the service request transfer unit 106 of the fee payment GW 12 transmits the service request including the specified service information and the specific ID, to the pool account management server 26. The bank service execution unit 116 (balance inquiry unit 118) of the pool account management server 26 performs data processing for balance inquiry, on the basis of the specific ID. For example, the fee amount associated with the specific ID included in the service request, is identified with reference to the payment information stored in the payment information retaining unit 110, and then balance information indicating the fee amount is transmitted to the fee payment GW 12.

The relay service execution unit 108 of the fee payment GW 12 transmits the balance information indicating the fee amount, received from the pool account management server 26, to the ATM 20 (S83). The ATM 20 displays the balance information indicating the fee amount, onto a screen (S84). Note that, the processing sequence illustrated in the sequence diagram is exemplary, and thus the processing at S75 may be performed before S74, for example. The processing at S80 may be performed before S77, to transmit the service request including the bank information from the ATM 20 to the fee payment GW 12. The user may directly input the specific ID onto a screen of the ATM 20 instead of recording the specific ID into the individual number card.

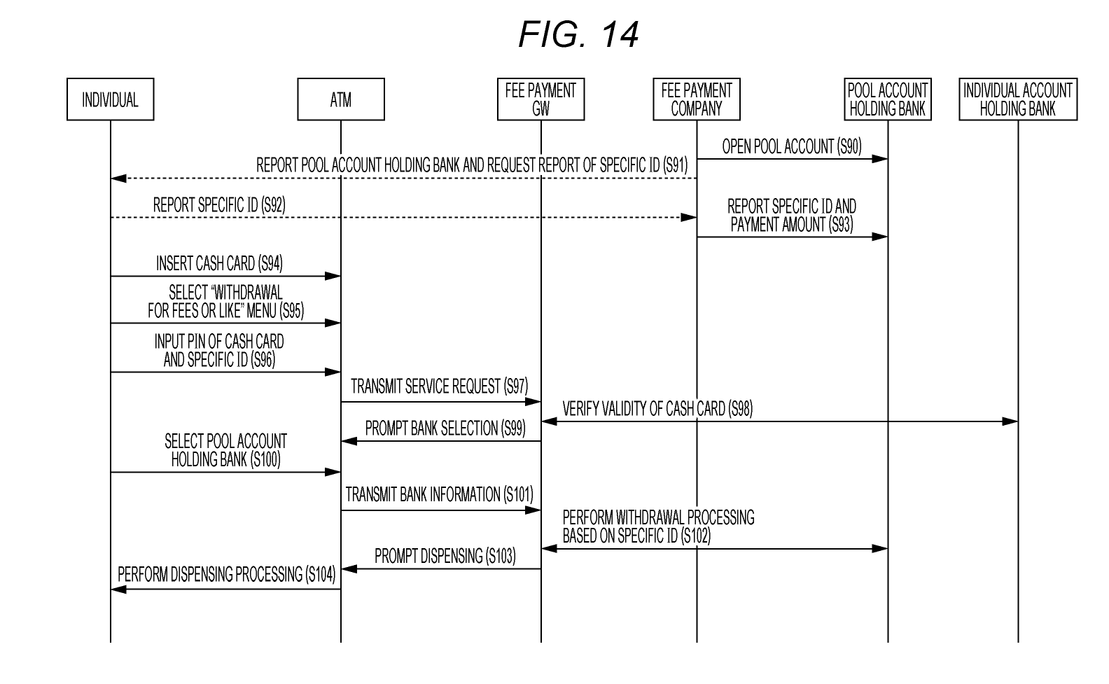

FIG. 14 is also a sequence diagram of the operation of the fee payment assistance system 10 according to the fourth embodiment. FIG. 14 illustrates the operation when the user selects money withdrawal as the bank service, with a cash card of a user's individual account. FIG. 14 illustrates a method in which the user determines the specific ID and notifies the fee payment company of the specific ID, as a method of sharing the specific ID between the fee payment company and the user.

The company PC 24 of the fee payment company transmits the pool account opening request to the pool account management server 26, and the money pool management unit 94 of the pool account management server 26 opens the pool account of the fee payment company (S90). At fee payment timing to the user, the person in charge in the fee payment company notifies the user of the name of the pool account holding bank and additionally requests the user to report the specific ID (S91). The user determines the specific ID and notifies the fee payment company of the specific ID (S92). The processing at S91 and S92 may be performed online, for example, by e-mail.

The person in charge in the fee payment company causes the company PC 24 to transmit the payment information including the specific ID, the payment amount, and the account number of the pool account, to the pool account management server 26 (S93). The payment information acquisition unit 112 of the pool account management server 26 acquires the payment information transmitted from the fee payment company, to store the payment information into the payment information retaining unit 110.

The use inserts the cash card into the ATM 20 (S94) and then selects “withdrawal for fees or the like” on the menu screen of the ATM 20 (S95). The ATM 20 displays a PIN input screen, and the user inputs the PIN code of the cash card and the specific ID onto the PIN input screen (S96). The ATM 20 transmits the service request including: the specified service information indicating “withdrawal for fees or the like”; card information read from the cash card; and the PIN code and the specific ID input by the user, to the fee payment GW 12 (S97).

The validity verification unit 74 of the fee payment GW 12 verifies the validity of the cash card, on the basis of the card information regarding the cash card and the PIN code, in cooperation with the individual account management server 28 (S98). When it is determined that the cash card is valid, the fee payment GW 12 prompts the ATM 20 to display the bank selection screen (S99). The subsequent processing at S100 and S101 is similar to that at S80 and S81 of FIG. 13.

The fee payment GW 12 performs money withdrawal processing based on the specific ID, in cooperation with the pool account management server 26 (S102). Specifically, the service request transfer unit 106 of the fee payment GW 12 transmits the service request including the specified service information and the specific ID, to the pool account management server 26. The bank service execution unit 116 (withdrawal service unit 120) of the pool account management server 26 identifies the fee amount associated with the specific ID included in the service request, to perform predetermined data processing of causing the ATM 20 to dispense the fee amount. When receiving information regarding the effect that the dispensing of the fee amount is allowed, from the pool account management server 26, the relay service execution unit 108 of the fee payment GW 12 transmits data prompting the dispensing of the fee amount, to the ATM 20 (S103). The ATM 20 performs dispensing processing of the fee amount (S104).

A “transfer for fees or the like” menu, not illustrated in FIGS. 13 and 14, may be selected on the ATM 20. In this case, in FIG. 13, the user may input a transfer destination account number into the ATM 20 and then the service request including the transfer destination account number may be transmitted to the pool account management server 26. In FIG. 14, the fee payment GW 12 may identify the transfer destination account number from the cash card information and may transmit the service request including the transfer destination account number, to the pool account management server 26. The bank service execution unit 116 (transfer service unit 122) of the pool account management server 26 may perform data processing of transferring the fee amount associated with the specific ID, from the pool account to the transfer destination account.

Not illustrated in FIGS. 13 and 14, when it is not verified that the electronic certificate of the individual number card (or cash card information) is valid, in other words, when it is verified that the information is invalid, the fee payment GW 12 inhibits the service request including the specific ID from being transmitted to the pool account management server 26. This arrangement can prevent a transaction with an individual number card or a cash card that is invalid or illegal, so that the security of fee payment can improve.

Similarly to the first to third embodiments, the fee payment GW 12 functions as a platform for the fee payment, in the fee payment assistance system 10 according to the fourth embodiment. The fee payment company is required at least to collectively deposit money to be paid to a large number of individuals, in the pool account, so that affairs concerning the fee payment can be rendered efficient. The fee payment company can easily perform high-frequency fee payment to a large number of individuals.

### Fifth Embodiment

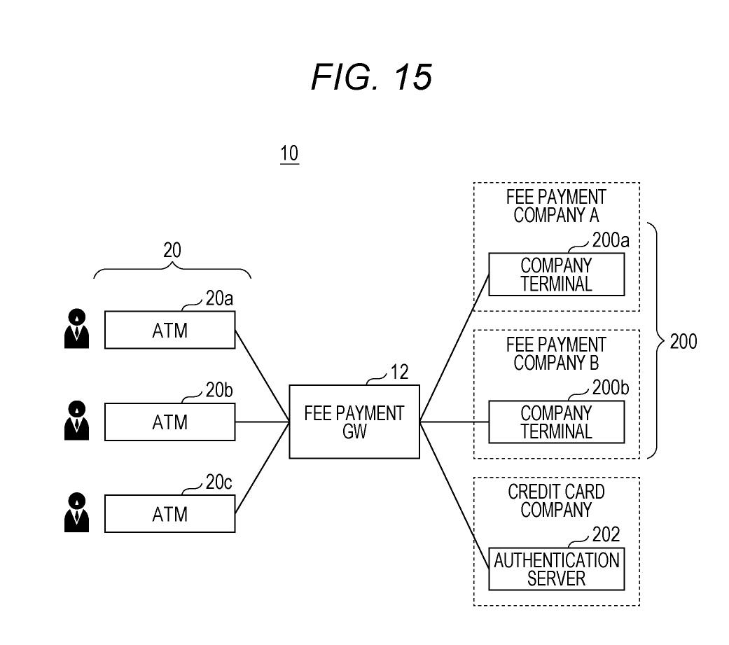

Similarly to the second to fourth embodiments, a fee payment assistance system 10 according to a fifth embodiment is an information processing system that assists money payment from a money pool that collectively holds money to be paid to a plurality of individuals by a money payment agent, to each individual. FIG. 15 illustrates the configuration of the fee payment assistance system 10 according to the fifth embodiment. From the constituent elements illustrated in FIG. 15, constituent elements the same as or corresponding to those already described in the embodiments, are denoted with the same reference signs. Descriptions duplicating those according to the embodiments will be appropriately omitted and differences will be mainly described below.

Company terminals 200a and 200b collectively referred to as a company terminal 200 correspond to the company servers 14a and 14b according to the second embodiment, and are information processing devices that a plurality of money payment agents (fee payment companies A and B) operate, respectively. An authentication server 202 is an information processing device managed by a credit card company. The authentication server 202 performs processing of verifying the validity of a specified credit card number on the basis of a request from a fee payment GW 12, and returns a verification result indicating whether the specified credit card number is valid, to the fee payment GW 12.

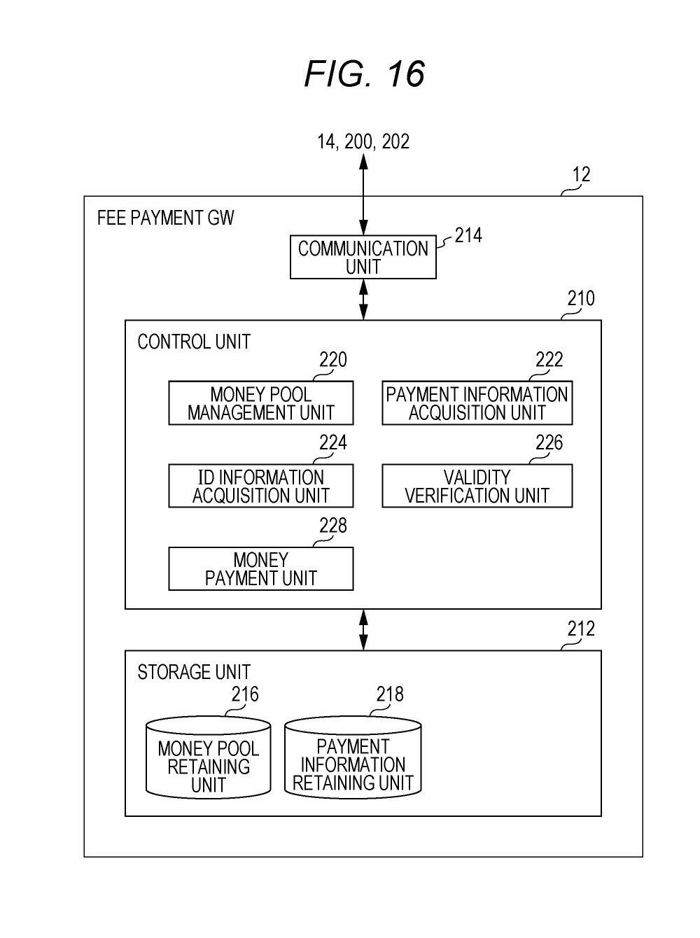

FIG. 16 is a block diagram of the functional configuration of the fee payment GW 12 of FIG. 15. A storage unit 212, a control unit 210, and a communication unit 214 of FIG. 16 correspond to the storage unit 62, the control unit 60, and the communication unit 64 according to the second embodiment (refer to FIG. 7), respectively. The storage unit 212 includes a money pool retaining unit 216 and a payment information retaining unit 218. The control unit 210 includes a money pool management unit 220, a payment information acquisition unit 222, an ID information acquisition unit 224, a validity verification unit 226, and a money payment unit 228.

The money pool retaining unit 216 corresponds to the money pool retaining unit 90 according to the second embodiment, and stores information regarding respective pool accounts opened by the fee payment companies A and B. Specifically, for each of the pool accounts opened by the fee payment companies A and B, the money pool retaining unit 216 retains the ID of the fee payment company, an account number, and a deposit balance in association with each other.

The payment information retaining unit 218 corresponds to the payee information retaining unit 92 according to the second embodiment, and retains payment information. The payment information includes the ID of the fee payment company, the ID of a fee payment destination individual, a payment amount to the individual (also regarded as a fee amount or a withdrawal amount from the pool account). The ID of the individual according to the present embodiment is the number of a credit card possessed by the individual (hereinafter, referred to as a “credit card number”), and is typically stated on the credit card.

The money pool management unit 220 corresponds to the money pool management unit 94 according to the second embodiment, and performs data processing concerning management of the pool account. For example, the money pool management unit 220 receives a pool account opening request from each of the company terminals 200a and 200b, and records information regarding the pool account into the money pool retaining unit 216. The money pool management unit 220 receives a money deposit request for the opened pool account, from each of the company terminals 200a and 200b, and increases the balance of the pool account corresponding to the requesting company. The money deposit to the pool account may be achieved by a publicly known Internet banking method.

The payment information acquisition unit 222 corresponds to the payee information acquisition unit 96 according to the second embodiment, and receives a registration request for the payment information from each of the company terminals 200a and 200b. The payment information acquisition unit 222 stores the payment information including the ID of the fee payment company, the ID of the fee payment destination individual (credit card number in the present embodiment), and the payment amount to the individual, specified by the registration request, into the payment information retaining unit 218.

The ID information acquisition unit 224 corresponds to the ID information acquisition unit 72 according to the second embodiment, and acquires, when a user requests fee reception, ID information regarding the user input into an ATM 20. The ID information acquisition unit 224 is also regarded as a card information acquisition unit, and acquires credit card information regarding the user transmitted from the ATM 20 as the ID information regarding the user. Specifically, the credit card information includes the credit card number read from the credit card and the PIN code of the credit card input into the ATM 20 by the user. Note that, even when a different user selects a fee reception menu on the same ATM 20 or a different ATM 20, the ID information acquisition unit 224 also acquires the credit card information regarding the different user.

The validity verification unit 226 corresponds to the validity verification unit 74 according to the second embodiment, and verifies the validity of a credit card possessed by each of a plurality of users that uses the ATM 20, in cooperation with the authentication server 202. Specifically, the validity verification unit 226 transmits the credit card number and the PIN code acquired by the ID information acquisition unit 224, to the authentication server 202, and then receives information indicating whether the credit card number is valid, in other words, whether the credit card number and the PIN code have been successfully authenticated, from the authentication server 202.

The money payment unit 228 corresponds to the money payment unit 78 according to the second embodiment, and performs processing of paying the fee amount previously specified by the fee payment company, the fee amount being part of money deposited in the pool account of the fee payment company, to each user of the ATM 20. Specifically, when it is verified that the credit card number input from the ATM 20 is valid, the money payment unit 228 specifies the ID of the fee payment company and the payment amount associated with the credit card number in the payment information in the payment information retaining unit 218. The money payment unit 228 withdraws the specified payment amount from the pool account of the specified fee payment company (e.g., subtracts the payment amount from the balance). In addition, the money payment unit 228 transmits data prompting dispensing of the specified payment amount, to the ATM 20, to cause the ATM 20 to perform processing of dispensing the payment amount.

When the payment information retaining unit 218 stores a plurality of items of payment information specifying the credit card number input from the ATM 20 (here, a plurality of items of payment information transmitted from one fee payment company), the money payment unit 228 withdraws the total amount of the payment amounts specified with the plurality of items of payment information, from the pool account of the one fee payment company. In addition, the money payment unit 228 transmits data prompting dispensing of the total amount of the payment amounts specified with the plurality of items of payment information, to the ATM 20, to cause the ATM 20 to perform processing of dispensing the total amount.

When the payment information retaining unit 218 stores a plurality of items of payment information specifying the credit card number input from the ATM 20, the plurality of items of payment information being different from each other in terms of the ID of the fee payment company, the money payment unit 228 withdraws the payment amount specified with each item of payment information, from the pool account of the fee payment company specified with each item of payment information. In addition, the money payment unit 228 transmits data prompting dispensing of the total amount of the payment amounts specified with the plurality of items of payment information, to the ATM 20, to cause the ATM 20 to perform processing of dispensing the total amount.

The operation of the fee payment assistance system 10 having the configuration, will be described.

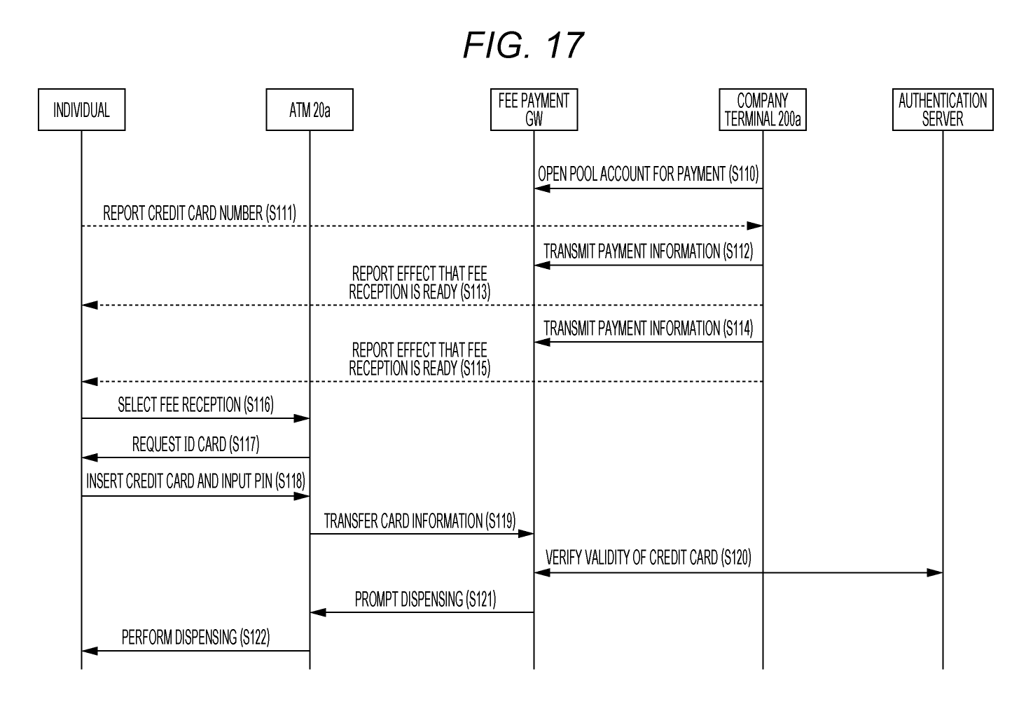

FIG. 17 is a sequence diagram of the operation of the fee payment assistance system 10 according to the fifth embodiment. FIG. 17 illustrates the operation when the fee payment company A schedules the fee payment to the same user a plurality of times and then the user operates an ATM 20a to collectively acquire the fees for the plurality of times.

The fee payment company A opens the pool account for payment, in the fee payment GW 12 (S110). For example, the company terminal 200a may transmit the pool account opening request to the fee payment GW 12 online. The money pool management unit 220 of the fee payment GW 12 may perform processing of opening the pool account in response to the request, and may store information regarding the new pool account, into the money pool retaining unit 216. A person in charge in the fee payment company A may contact an administrator of the fee payment GW 12 by telephone or e-mail, to request the opening of the pool account, and then the administrator of the fee payment GW 12 may perform work of opening the pool account.

The user notifies the fee payment company A of the credit card number possessed by the user, by means, such as telephone or e-mail (S111). At fee payment timing to the user, the company terminal 200a registers the payment information specifying the ID of the host company, the credit card number of the user, and the payment amount, into the fee payment GW 12 (S112). The fee payment company A notifies the user of the effect that fee reception is ready (S113). At the next fee payment timing to the user, the fee payment company A registers the next payment information into the fee payment GW 12 (S114), and then notifies the user of the effect that the next fee reception is ready (S115).

When the user selects fee reception on a menu screen of the ATM 20a (e.g., refer to FIG. 5A) (S116), a display control unit 46 of the ATM 20a displays a screen prompting insertion of the credit card and input of the PIN code, onto an LCD 30 (S117). The user inserts the credit card into the ATM 20a and then inputs the PIN code of the credit card into the ATM 20a (S118). A card information transmission unit 48 of the ATM 20a transmits the credit card number read by a card reader 32 and the PIN code input by the user, to the fee payment GW 12 (S119).

The ID information acquisition unit 224 of the fee payment GW 12 acquires the credit card number of the user and the PIN code transmitted from the ATM 20a. The validity verification unit 226 verifies whether the credit card number of the user is valid, in other words, is invalid, in cooperation with the authentication server 202 (S120). When the credit card number of the user is valid, the money payment unit 228 searches the plurality of items of payment information registered in the payment information retaining unit 218, with the credit card number of the user as a key. The money payment unit 228 calculates the total amount of the payment amounts indicated with at least one item of payment information matched on the search (here, the two items of payment information registered at S112 and S114). The money payment unit 228 withdraws the total amount from the pool account of the fee payment company A, and prompts the ATM 20a to dispense the total amount (S121). A dispensing control unit 50 of the ATM 20a performs processing of dispensing the total amount in accordance with the prompt of the fee payment GW 12 (S122).

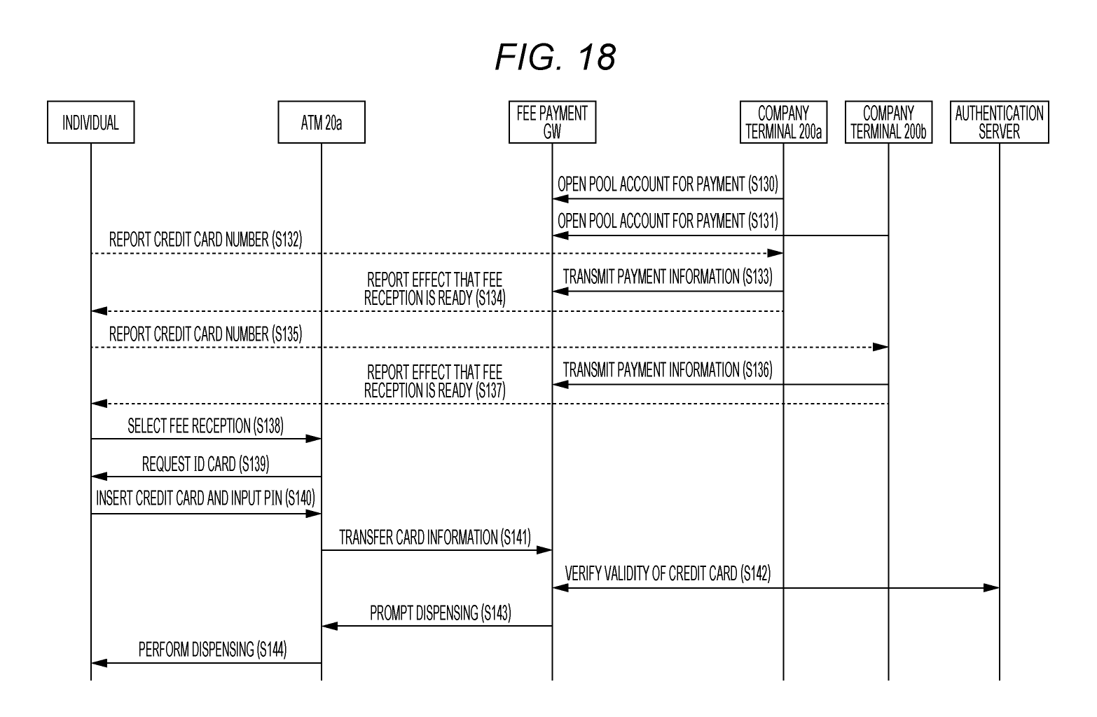

FIG. 18 is also a sequence diagram of the operation of the fee payment assistance system 10 according to the fifth embodiment. FIG. 18 illustrates the operation when the fee payment companies A and B both schedule the fee payment to the same user and then the user operates the ATM 20a to collectively acquire the fees from both companies.

The fee payment company A opens the pool account for payment, in the fee payment GW 12 (S130), and the fee payment company B also opens the pool account for payment, in the fee payment GW 12 (S131). The user notifies the fee payment company A of a credit card number possessed by the user (S132). At fee payment timing to the user, the company terminal 200a registers first payment information specifying the ID of the host company, the credit card number of the user, and the payment amount (here, referred to as a “first payment amount”), into the fee payment GW 12 (S133). The fee payment company A notifies the user of the effect that fee reception is ready (S134).

Similarly, the user notifies the fee payment company B of a credit card number possessed by the user (here, the same number at S132) (S135). At fee payment timing to the user, the company terminal 200b registers second payment information specifying the ID of the host company, the credit card number of the user, and the payment amount (here, referred to as a “second payment amount”), into the fee payment GW 12 (S136). The fee payment company B notifies the user of the effect that fee reception is ready (S137).

The subsequent processing from S138 to S142 is the same as that at S116 to S120 of FIG. 17, and thus the descriptions thereof will be omitted. When the credit card number of the user is valid, the money payment unit 228 searches the plurality of items of payment information registered in the payment information retaining unit 218, with the credit card number of the user as the key. Here, the first payment information and the second payment information are specified. The money payment unit 228 withdraws the first payment amount indicated with the first payment information, from the pool account of the fee payment company A, and withdraws the second payment amount indicated with the second payment information, from the pool account of the fee payment company B. The money payment unit 228 prompts the ATM 20a to dispense the total amount of the first payment amount and the second payment amount (S143). The dispensing control unit 50 of the ATM 20a performs processing of dispensing the total amount in accordance with the prompt of the fee payment GW 12 (S144).

The fee payment GW 12 is provided with the pool account for each fee payment company. Thus, similarly to the second embodiment, both for fee reception of a first user and for fee reception of a second user different from the first user, substantially the same processing is performed (e.g., processing from S111 to S122 of FIG. 17 or processing from S132 to S144 of FIG. 18). If having the fee payment to the first user and the fee payment to the second user, registered by the fee payment company A, the fee payment GW 12 withdraws the fee amount to the first user and the fee amount to the second user, from the same pool account of the fee payment company A.

In the fee payment assistance system 10 according to the fifth embodiment, each fee payment company is required at least to collectively deposit money to be paid to a large number of individuals, into the pool account, so that affairs concerning the fee payment can be rendered efficient. When a single fee payment company performs the fee payment to the user being the fee payee a plurality of times or when a plurality of fee payment companies performs the fee payment to the user being the fee payee a plurality of times, the user does not need to pay attention to the individual fee payment but can collectively acquire the fees paid the plurality of times at different timing. The user does not need to input ID varying for each fee, into the ATM 20 for respective procedures to the plurality of fees, so that the convenience of the user can improve.

A modification will be described. According to the fifth embodiment, the fee is acquired with the credit card as an exemplary proposal, but the fee may be acquired with a cash card similarly to the first embodiment or the fee may be acquired with an individual number card similarly to the second to fourth embodiments. For example, application of the configuration of the money payment unit 228 according to the fifth embodiment, to the fee payment GW 12 according to the first to fourth embodiments, enables the fees paid a plurality of times to be collectively acquired with the cash card or the individual number card. Note that, the user may input the credit card number after insertion of the cash card into the ATM 20 and selection of the fee reception menu. In this case, when it is verified that the credit card number is valid, the fees paid a plurality of time may be collectively transferred to the account of the user indicated with the cash card. As described in the fourth embodiment, the pool account of the fee payment company, may be managed by a device of a financial institution (e.g., bank) instead of the fee payment GW 12.

Another modification will be described. No described in the fifth embodiment, the user may insert the individual number card into the ATM 20 and the ATM 20 may read the ID information including the My Number of the user, from the individual number card, to transmit the ID information to the fee payment GW 12. For example, the processing from S36 to S37 of FIG. 8 may be performed. The fee payment GW 12 may automatically create a legal record (e.g., withholding certificate) with the ID information (My Number) transmitted from the ATM 20 and may provide the user and the fee payment company with the legal record. For example, the processing from S38 to S48 of FIG. 8 may be performed. Note that, even when the user is provided collectively with the total amount of the payment amounts indicated with a plurality of items of payment information, a legal record indicating the fact of money payment may be created for each item of payment information, in other words, a plurality of legal records corresponding to the plurality of items of payment information may be created.

Yet another modification will be described. The fee reception with the credit card described in the fifth embodiment, may be applied to the first to fourth embodiments. That is, the user may insert the credit card into the ATM 20 instead of the cash card or the individual number card in the first to fourth embodiments. When the validity of the credit card number reported from the ATM 20 is verified, the fee payment GW 12 may cause the ATM 20 to dispense the fee.

### Sixth Embodiment

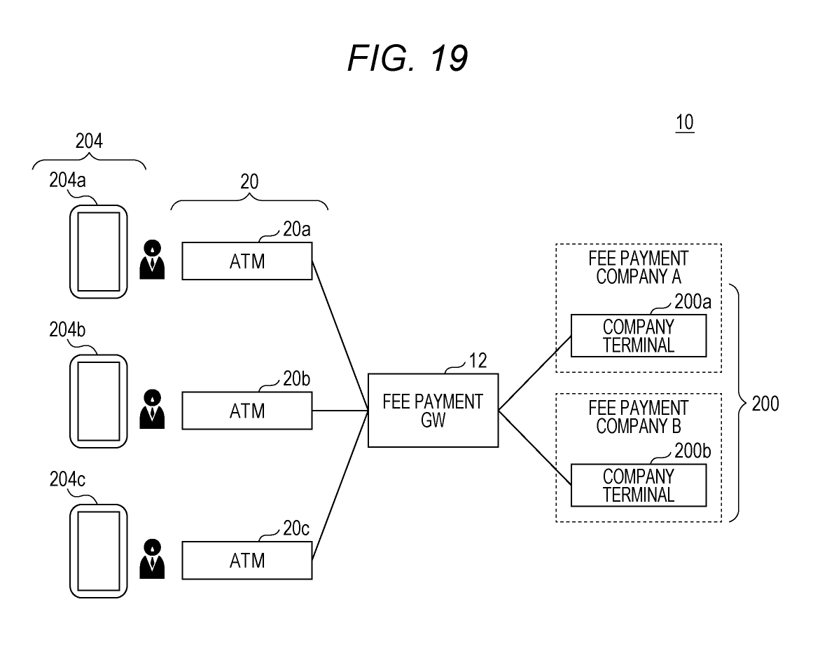

Similarly to the second to fifth embodiments, a fee payment assistance system 10 according to a sixth embodiment is an information processing system that assists money payment from a money pool that collectively holds money to be paid to a plurality of individuals by a money payment agent, to each individual. FIG. 19 illustrates the configuration of the fee payment assistance system 10 according to the sixth embodiment. From the constituent elements illustrated in FIG. 19, constituent elements the same as or corresponding to those already described in the embodiments, are denoted with the same reference signs. Descriptions duplicating those according to the embodiments will be appropriately omitted and differences will be mainly described below.

The fee payment assistance system 10 includes respective portable terminals 204 possessed by a plurality of users (portable terminals 204a, 204b, and 204c). Each of the portable terminals 204a, 204b, and 204c is, for example, a smartphone or a tablet terminal, and is connected to a fee payment GW 12 through a communication network, such as the Internet. Each portable terminal 204 has a function of verifying whether an operator is the correct identical user, for example, the function including at least one of a fingerprint authentication function and a pattern authentication function.

Each portable terminal 204 has an application for fee reception (hereinafter, also referred to as a “fee reception App”) provided on a digital content distribution site on the Internet, previously installed. The fee reception App has the following four functions. (1) A function of issuing ID for fee reception (hereinafter, referred to as “reception ID”) and displaying the ID on a screen. (2) A function of registering identification information regarding the portable terminal 204 (ID at least unique for each terminal, hereinafter, referred to as “terminal ID”) and a public key into the fee payment GW 12. (3) A function of encrypting the reception ID with a secret key of the portable terminal 204 and transmitting encrypted data thereof and the terminal ID to the fee payment GW 12. (4) A function of acquiring a one-time password from the fee payment GW 12 and displaying the one-time password on a screen.

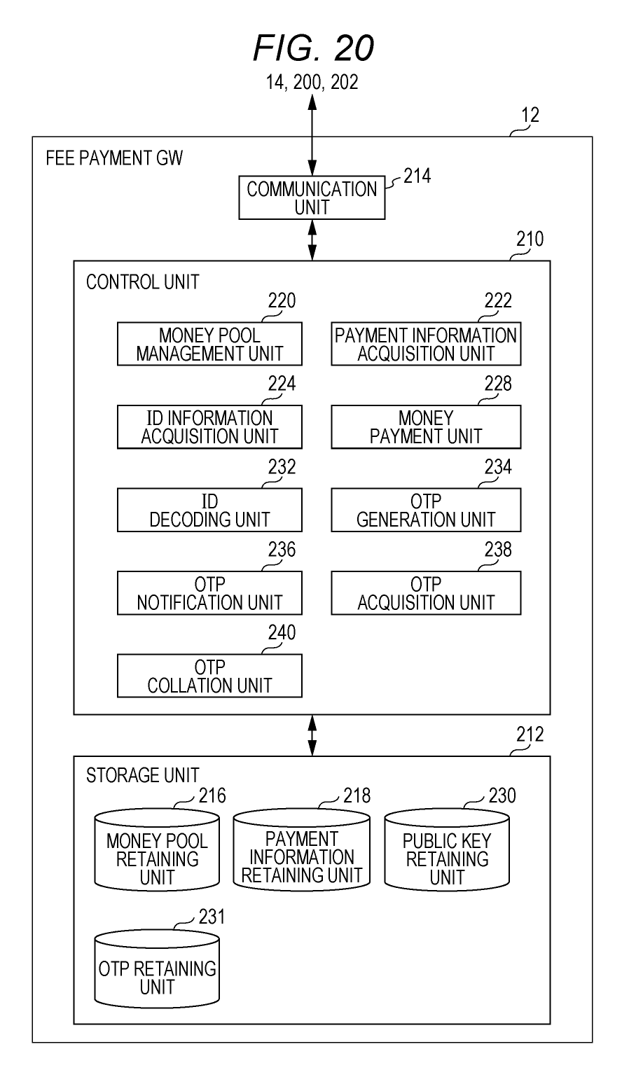

FIG. 20 is a block diagram of the functional configuration of the fee payment GW 12 of FIG. 19. A storage unit 212 includes a money pool retaining unit 216, a payment information retaining unit 218, a public key retaining unit 230, and a OTP retaining unit 231. A control unit 210 includes a money pool management unit 220, a payment information acquisition unit 222, an ID information acquisition unit 224, a money payment unit 228, an ID decoding unit 232, a OTP generation unit 234, a OTP notification unit 236, a OTP acquisition unit 238, and a OTP collation unit 240. Differences from the fifth embodiment (refer to FIG. 16) will be described below.

The public key retaining unit 230 associates and stores the respective terminal IDs and public keys registered from the plurality of portable terminals 204. The OTP retaining unit 231 associates and stores the one-time password, the valid period of the one-time password, and the reception ID reported from the portable terminal 204.

The payment information acquisition unit 222 receives a registration request for payment information from each of a company terminal 200a and a company terminal 200b, and stores the payment information including the ID of a fee payment company, the ID of a fee payment destination individual, and the payment amount to the individual, specified by the registration request, into the payment information retaining unit 218. The ID of the individual according to the present embodiment, is the reception ID issued by the fee reception App.

The ID information acquisition unit 224 acquires, as the ID of a user individual, the terminal ID and the encrypted data of the reception ID transmitted from the portable terminal 204. The ID decoding unit 232 decodes the encrypted data transmitted from the portable terminal 204, with the public key associated with the terminal ID in the public key retaining unit 230, to acquire the original reception ID.

The OTP generation unit 234 generates the one-time password when the ID decoding unit 232 succeeds in the decoding processing. The one-time password may include a character string valid only for a predetermined time (e.g., for five minutes) after the generation. The OTP generation unit 234 associates and stores the one-time password generated, the valid period thereof, and the reception ID decoded by the ID decoding unit 232, into the OTP retaining unit 231.

The OTP notification unit 236 transmits data of the one-time password generated by the OTP generation unit 234, to the portable terminal 204 being a reception ID source. The OTP acquisition unit 238 acquires the one-time password input into an ATM 20 by the user.

The OTP collation unit 240 collates the one-time password acquired by the OTP acquisition unit 238 with the one-time password stored in the OTP retaining unit 231. The OTP collation unit 240 determines that the collation is successful, when the one-time password acquired by the OTP acquisition unit 238 is present in the OTP retaining unit 231 and the one-time password is within the valid period associated therewith.

When the OTP collation unit 240 succeeds in the collation of the one-time password, the money payment unit 228 searches a plurality of items of payment information stored in the payment information retaining unit 218, with, as a key, the reception ID retained in association with the one-time password, to specify the payment information specifying the reception ID (namely, the ID of the fee payment company and the payment amount). The money payment unit 228 withdraws the specified payment amount from a pool account of the specified fee payment company. In addition, the money payment unit 228 transmits data prompting dispensing of the specified payment amount, to the ATM 20.

The operation of the fee payment assistance system 10 having the configuration, will be described.

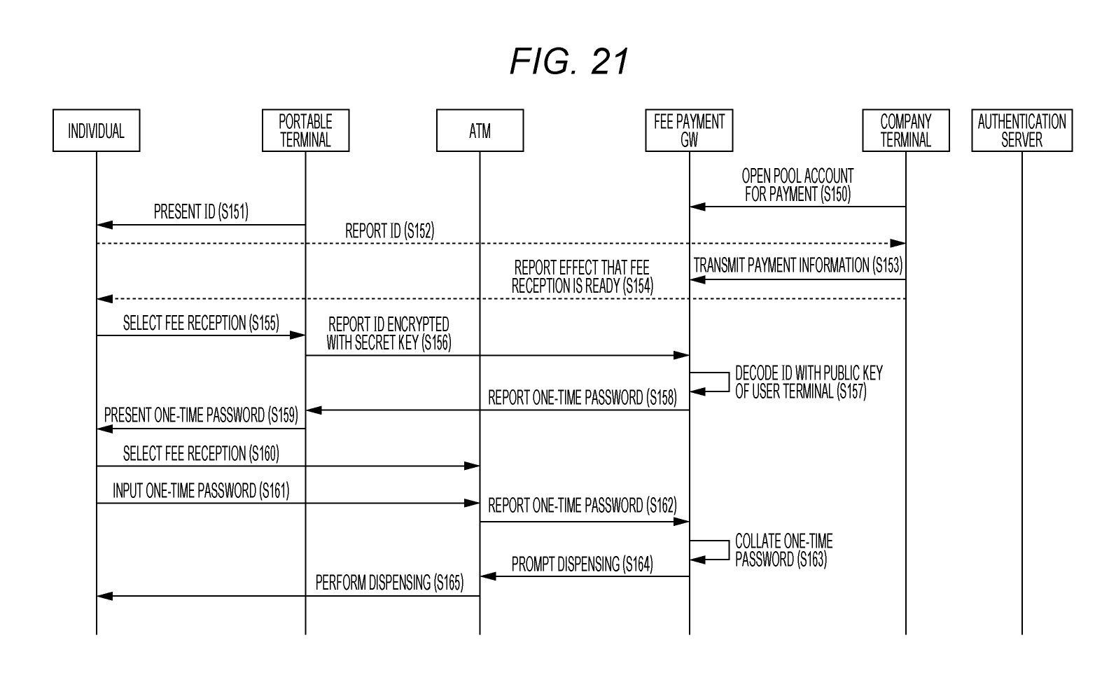

FIG. 21 is a sequence diagram of the operation of the fee payment assistance system 10 according to the sixth embodiment. Not illustrated in FIG. 21, the portable terminal 204 has the fee reception App installed, and the fee reception App previously registers the public key and unique terminal ID of the host terminal into the fee payment GW 12. The fee payment company (here, fee payment company A) opens the pool account for payment, in the fee payment GW 12 (S150).

The user boots the fee reception App of the portable terminal 204 and then selects a reception ID issue menu. The fee reception App of the portable terminal 204 issues the unique reception ID and displays the reception ID on the display (S151). The user notifies a person in charge in the fee payment company, of the reception ID online or offline (S152). At fee payment timing to the user, the company terminal 200a registers the payment information specifying the ID of the host company, the reception ID reported by the user, and the payment amount, into the fee payment GW 12 (S153). The fee payment company A notifies the user of the effect that fee reception is ready (S154).

The user boots the fee reception App of the portable terminal 204 and then selects a fee reception menu (S155). The fee reception App of the portable terminal 204 transmits encrypted data including the reception ID issued at S151, encrypted with the secret key of the host terminal, together with the terminal ID, to the fee payment GW 12 (S156). The ID decoding unit 232 of the fee payment GW 12 decodes the encrypted data transmitted from the portable terminal 204, with the public key of the portable terminal 204 associated with the terminal ID transmitted from the portable terminal 204 (S157). When the decoding is successful (e.g., when the reception ID is acquired in a correct format by the decoding), the OTP generation unit 234 generates the one-time password and the OTP notification unit 236 transmits the one-time password to the portable terminal 204 (S158). The fee reception App of the portable terminal 204 displays the one-time password transmitted from the fee payment GW 12, onto the display (S159).

The user selects fee reception on a menu screen of the ATM 20 (e.g., refer to FIG. 5A) (S160), and then inputs the one-time password displayed on the portable terminal 204, into the ATM 20 (S161). The ATM 20 transmits the one-time password input by the user, to the fee payment GW 12 (S162). The OTP collation unit 240 of the fee payment GW 12 verifies whether the one-time password transmitted from the ATM 20 is identical to the one-time password generated by the OTP generation unit 234 (S163). When the two are identical to each other, the money payment unit 228 extracts the payment information specifying the reception ID acquired at 5157, withdraws the payment amount indicated with the payment information from the pool account of the fee payment company A, and then prompts the ATM 20 to dispense the payment amount (S164). A dispensing control unit 50 of the ATM 20 performs dispensing processing of the payment amount, in accordance with the prompt of the fee payment GW 12 (S165).

The fee payment assistance system 10 according to the six embodiment, can verify that the correct identical user is requesting the fee reception, on the premise that the portable terminal 204 authenticates the user, for example, with the fingerprint authentication. This arrangement can prevent the fee to be received by the correct user, from being acquired by a third party impersonating the correct user.

As a modification, the issue of the one-time password may be omitted from the configuration according to the sixth embodiment, and then the user may input the reception ID presented at S151 of FIG. 21, into the ATM 20. The fee payment GW 12 may perform fee payment processing, on the basis of the payment information specifying the reception ID transmitted from the ATM 20. According to the modification, it can be verified that the portable terminal 204 used by the user is correct and the authentication of the user with the portable terminal 204 is successful, for example, at S157 of FIG. 21, and thus impersonation is easily eliminated.

As another modification, the fee reception App of the portable terminal 204 may register the reception ID (in plain text) in registering the public key of the host terminal into the fee payment GW 12. When decoding the reception ID at S157, the fee payment GW 12 may compare the reception ID as a result of the decoding, with the reception ID previously registered. If the two are identical to each other, the fee payment GW 12 may determine that the collation is successful and may proceed to the processing from S158.

As still another modification, the configuration according to the sixth embodiment can be combined with the configuration according to a different embodiment. For example, after the performance of the processing from S151 to S159 of FIG. 21, the user may insert a cash card, an individual number card, or a credit card into the ATM 20 and then may input both of the PIN of the card and the one-time password presented at S159 into the ATM 20. When the collation of the one-time password is successful, the fee payment GW 12 may perform the fee payment processing described in each embodiment.

As yet another modification, positional authentication of the portable terminal 204 may be further performed with a technique such as the GPS, iBeacon (trademark or registered trademark), Bluetooth (trademark or registered trademark) Low Energy, or a NFC tag. For example, with at least one of the techniques, the fee reception App of the portable terminal 204 may acquire the current position of the host terminal and may transmit data indicating the current position, to the fee payment GW 12. When the current position of the portable terminal 204 satisfies a predetermined condition, the fee payment GW 12 may determine that the authentication is successful, and may perform the subsequent fee payment processing for the authentication success (e.g., issue of the one-time password). For example, the predetermined condition may include a range within a predetermined distance from the location at which the ATM 20 is installed, a range in the region in which the user resides (e.g., country), or a range in proximity to the region.

Note that, Japanese Patent No. 4755865 has been granted as a technique of determining the correctness of a user on the basis of the position of a terminal; the entire contents of which are incorporated herein by reference.

As a further modification, whether the holder of the portable terminal 204 is the correct user, may be determined by a method different from the method in which the user inputs the one-time password displayed on the portable terminal 204 into the ATM 20. For example, for the telephone number of the portable terminal 204 previously registered in the fee payment GW 12, the user may input the telephone number of the portable terminal 204 into the ATM 20. When the telephone number input into the ATM 20 is identical to the previously registered telephone number, the fee payment GW 12 may perform the money payment processing.

A further different method of determining whether the holder of the portable terminal 204 is the correct user, with the ATM 20, can be considered. For example, for the portable terminal 204 and the ATM 20 supporting Near Field Communication (NFC), data stored in the portable terminal 204 (e.g., one-time password or telephone number) may be input from the portable terminal 204 to the ATM 20, the portable terminal 204 being in contact with or close to a predetermined region of the ATM 20. The ATM 20 may read QR code (registered trademark) displayed on the portable terminal 204. When the position of the portable terminal 204 is verified in the modification, the user may input the telephone number of the portable terminal 204 into the ATM 20. The fee payment GW 12 after receiving the telephone number, may transmit push notification to the portable terminal 204 and then the portable terminal 204 may display a screen based on the push notification. When the user inputs a predetermined operation to the screen (e.g., selection of a predetermined button), a program of the screen may acquire positional information regarding the portable terminal 204 and then may transmit the positional information to the fee payment GW 12. Similarly to the modification, the fee payment GW 12 may perform the fee payment processing in response to the positional information received from the portable terminal 204.

According to the first to sixth embodiments, the fee payment is exemplary and the payment agent is a company, but the technical idea according to each embodiment is not limited to this. The technical idea according to each embodiment can be widely applied for money transmission from various payment agents including a company and an individual, to an individual. The technical idea according to each embodiment can be applied for refund processing from a seller to a purchaser, for example, in returning of a commodity purchased by cash on delivery in mail order. The technical idea according to each embodiment can be applied for money payment from an individual to an individual in a consumer to consumer (C to C) transaction.

The present invention has been described above on the basis of the first to sixth embodiments. A person skilled in the art should understand that the embodiments are exemplary, various modifications may be made with combinations of the constituent elements and the processing processes, and the modifications are included in the scope of the present invention.

Any combinations of the embodiments and the modifications are each also useful as an embodiment of the present invention. A new embodiment caused by a combination includes respective effects of an embodiment and a modification included in the combination. The person skilled in the art should understand that the function to be performed by each constituent feature described in the claims is to be achieved by a simple of each of the constituent elements described in the embodiments and the modifications, or in cooperation thereof.

The present invention can be applied to an information processing device that assists money payment.

What is claimed is:

1. An information processing device comprising:
a money pool management unit configured to manage a plurality of money pools corresponding to a plurality of money payment agents, each money pool collectively holding money to be paid to a plurality of individuals by the money payment agent;
a payment information storage unit configured to store, in response to a request from a device of each of the plurality of money payment agents, payment information specifying identification information regarding the money payment agent being a request source, identification information regarding a money payment destination, and a payment amount;
a money payment unit configured to withdraw, for input of a one-time password valid from a first external terminal operated by an individual, the payment amount specified with the one-time password from the money pool, the money payment unit being configured to cause the first external terminal to dispense the payment amount;
a one-time password storage unit; and
a one-time password notification unit, wherein
the payment information storage unit stores, as the identification information regarding the money payment destination, reception ID being unique ID generated by a second external terminal possessed by the individual being the money payment destination, the unique ID being reported to the money payment agent by the individual,
the one-time password storage unit associates and stores, for reception of the reception ID encrypted from the second external terminal, the reception ID decoded with a predetermined key of the second external terminal and the one-time password newly generated,
the one-time password notification unit notifies the second external terminal of the one-time password,
the money payment unit specifies, for the input of the one-time password from the first external terminal within a valid period, the reception ID stored in association with the one-time password input, and
the money payment unit withdraws, when the payment information storage unit stores a plurality of items of the payment information specifying the reception ID, the plurality of items of the payment information specifying different money payment agents, the payment amount specified with each item of the payment information from the money pool of the money payment agent specified with each item of the payment information, and causes the first external terminal to dispense a total amount of the respective payment amounts specified with the plurality of items of the payment information.

2. The information processing device according to claim 1, wherein
the first external terminal is an automatic teller machine (ATM), and
the second external terminal is a portable terminal possessed by a user.

3. An information processing method to be performed by a computer, the information processing method comprising:
managing a plurality of money pools corresponding to a plurality of money payment agents, each money pool collectively holding money to be paid to a plurality of individuals by the money payment agent;
storing, in response to a request from a device of each of the plurality of money payment agents, payment information specifying identification information regarding the money payment agent being a request source, identification information regarding a money payment destination, and a payment amount; and
withdrawing, for input of a one-time password valid from a first external terminal operated by an individual, the payment amount specified with the one-time password from the money pool, and causing the first external terminal to dispense the payment amount, wherein
the storing includes storing, as the identification information regarding the money payment destination, reception ID being unique ID generated by a second external terminal possessed by the individual being the money payment destination, the unique ID being reported to the money payment agent by the individual,
the computer further performs: associating and storing, for reception of the reception ID encrypted from the second external terminal, the reception ID decoded with a predetermined key of the second external terminal and the one-time password newly generated; and notifying the second external terminal of the one-time password, and
the withdrawing and causing include:
specifying, for the input of the one-time password from the first external terminal within a valid period, the reception ID stored in association with the one-time password input; and
withdrawing, for previously storage of a plurality of items of the payment information specifying the reception ID, the plurality of items of the payment information specifying different money payment agents, the payment amount specified with each item of the payment information from the money pool of the money payment agent specified with each item of the payment information, and causing the first external terminal to dispense a total amount of the respective payment amounts specified with the plurality of items of the payment information.
